(19) United States
(12) Patent Application Publication
(10) Pub. No.: US 2026/0222920 A1
(43) Pub. Date: Jul. 30, 2026

(54) INFORMATION PROCESSING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Yi XIONG, Beijing (CN); Yumin WU, Beijing (CN)

(21) Appl. No.: 19/145,293

(22) PCT Filed: Jan. 4, 2023
(86) PCT No.: PCT/CN2023/070564

§ 371 Date: Jul. 2, 2025

(51) Int. Cl. H04W 36/00; H04W 36/04; H04W 36/08; H04W 76/20

(52) U.S. Cl. CPC H04W 36/0016; H04W 36/04; H04W 36/08; H04W 76/20

(57) ABSTRACT

An information processing method is performed by user equipment (UE), and includes: receiving indication information sent by a first node, wherein the indication information indicates the UE to retain or delete configuration information related to a candidate cell or a candidate cell group stored by the UE.

### CROSS REFERENCE TO RELATED APPLICATION

The present application is a U.S. National Stage of International Application No. PCT/CN2023/070564, filed on Jan. 4, 2023, the content of which is incorporated herein by reference in its entirety,

### TECHNICAL FIELD

The present disclosure relates to, but not limited to, the field of wireless communication technologies, and in particular to an information processing method and apparatus, a communication device and a storage medium.

### BACKGROUND

In dual connectivity, User Equipment (UE) may access two cells or two cell groups at the same time. For example, a UE may access a Primary Cell (PCell) and a Secondary Cell (SCell) at the same time, or a UE may access a Master Cell Group (MCG) and a Secondary Cell Group (SCG) at the same time. A MCG includes multiple cells, one of which is used to initiate initial access, and this cell is called PCell. As the name suggests, PCell is the most important cell in the MCG. The other cells in the MCG except the PCell are SCells. The PCell in the MCG and SCell(s) in the MCG are combined through Carrier Aggregation (CA) to improve the transmission rate and meet users' requirements for rate.

### SUMMARY

Embodiments of the present disclosure provide an information processing method and apparatus, a communication device, and a storage medium.

A first aspect of an embodiment of the present disclosure provides an information processing method. The method is applied to user equipment. The method includes:

receiving indication information sent by a first node, wherein the indication information indicates the user equipment to retain or delete configuration information related to a candidate cell or a candidate cell group stored by the user equipment.

A second aspect of an embodiment of the present disclosure provides an information processing method. The method is applied to a first node. The method includes:

sending indication information to user equipment, wherein the indication information indicates the user equipment to retain or delete configuration information related to a candidate cell or a candidate cell group stored by the user equipment.

A further aspect of an embodiment of the present disclosure provides a communication device, including a processor, a transceiver, and a memory. When the processor executes the executable program stored in the memory, the information processing method provided in any one of the first to second aspects described above is implemented.

A further aspect of an embodiment of the present disclosure provides a non-transitory computer storage medium, which stores an executable program. After the executable program is executed by a processor, the information processing method provided in any one of the first to second aspects described above can be implemented.

Regarding the technical solutions provided by the embodiments of the present disclosure, it should be understood that the above general description and the following detailed description are merely illustrative and explanatory and cannot limit the embodiments of the present disclosure.

### BRIEF DESCRIPTION OF THE DRAWINGS

The accompanying drawings herein, which are incorporated in and constitute a part of the specification, illustrate embodiments consistent with the present disclosure, and together with the specification, serve to explain principles of the embodiments of the present disclosure.

FIG. 1 is a schematic structural diagram showing a wireless communication system according to an example embodiment;

FIG. 2 is a schematic diagram showing a dual connectivity architecture according to an example embodiment;

FIG. 3 is a schematic diagram showing another dual connectivity architecture according to an example embodiment;

FIG. 4 is a schematic diagram showing a master cell group and a secondary cell group according to an example embodiment;

FIG. 5 is a schematic diagram showing an information processing method according to an example embodiment;

FIG. 6 is a schematic diagram showing another information processing method according to an example embodiment;

FIG. 7 is a schematic diagram showing another information processing method according to an example embodiment;

FIG. 8 is a schematic diagram showing another information processing method according to an example embodiment;

FIG. 9 is a schematic diagram showing an information processing apparatus according to an example embodiment;

FIG. 10 is a schematic diagram showing another information processing apparatus according to an example embodiment;

FIG. 11 is a schematic diagram showing a wireless communication system according to an example embodiment;

FIG. 12 is a schematic diagram showing a wireless communication system according to an example embodiment;

FIG. 13 is a schematic diagram showing a structure of user equipment according to an example embodiment;

FIG. 14 is a schematic diagram showing a structure of a communication device according to an example embodiment.

### DETAILED DESCRIPTION

Example embodiments will be described in detail herein, examples of which are shown in the accompanying drawings. When the following description refers to the drawings, unless otherwise indicated, the same numbers in different drawings represent the same or similar elements. The implementations described in the following example embodiments do not represent all implementations consistent with the embodiments of the present disclosure. Instead, they are merely examples of apparatuses and methods consistent with some aspects of the embodiments of the present disclosure.

The terms used in the embodiments of the present disclosure are only for the purpose of describing example embodiments, and are not intended to limit the embodiments of the present disclosure. The singular forms such as “a/an”, “said” and “the” used in the present disclosure are also intended to include plural forms, unless the context clearly indicates other meanings. It should also be understood that the term “and/or” used herein refers to and includes any or all possible combinations of one or more associated listed items.

It should be understood that, although the terms such as first, second, third, etc. may be used to describe various types of information in the embodiments of the present disclosure, these types of information should not be limited to these terms. These terms are only used to distinguish the same type of information from each other. For example, without departing from the scope of the embodiments of the present disclosure, first information may also be referred to as second information, and similarly, the second information may also be referred to as the first information. Depending on the context, the word “if” as used herein may be interpreted as “when” or “in a case where . . . ” or “in response to determining . . . ”.

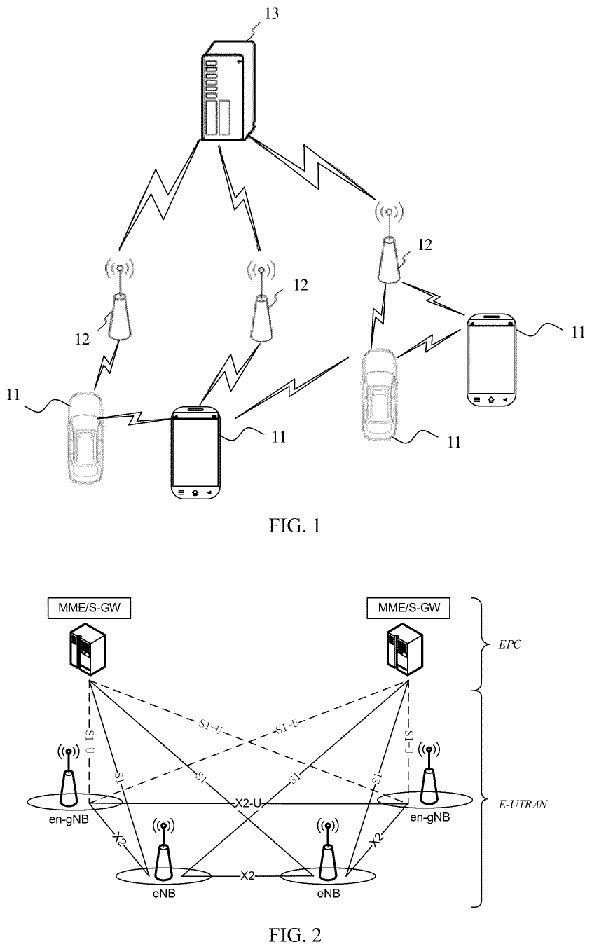

Referring to FIG. 1, a schematic structural diagram of a wireless communication system provided by an embodiment of the present disclosure is shown. As shown in FIG. 1, the wireless communication system is a communication system based on cellular mobile communication technologies. The wireless communication system may include at least one UE 11 and multiple core network devices.

A UE 11 may be a device that provides voice and/or data connectivity to a user. The UE 11 may communicate with one or more core networks via a Radio Access Network (RAN). The UE 11 may be an Internet of Things UE, such as a sensor device, a mobile phone (or referred to as a cellular phone), and a computer with Internet of Things UE, for example, it can be a fixed, portable, pocket-sized, handheld, computer-built-in or vehicle-mounted device. For example, the UE 11 may be a station (STA), a subscriber unit, a subscriber station, a mobile station, a mobile, a remote station, an access point, remote UE (remote terminal), access UE (access terminal), a user terminal, a user agent, a user device, or user equipment (UE). Alternatively, the UE 11 may be equipment of an unmanned aerial vehicle. Alternatively, the UE 11 may be a vehicle-mounted device, for example, it may be an on-board computer with a wireless communication function, or wireless communication device connected to an external on-board computer. Alternatively, the UE 11 may be a roadside device, for example, it may be a streetlight, a signal light or other roadside device with a wireless communication function.

An access device 12 may be a network device in a wireless communication system. The wireless communication system may be the 4th generation mobile communication (4G) system, also known as the Long Term Evolution (LTE) system; or, the wireless communication system may be a 5G system, also called new radio (NR) system or 5G NR system. Alternatively, the wireless communication system may be a next-generation system of the 5G system. The access network in the 5G system may be called New Generation-Radio Access Network (NG-RAN); alternatively, may be a MTC system.

The access device 12 may be an evolved access device (eNB) used in the 4G system. Alternatively, the access device 12 may be an access device (gNB) using a centralized distributed architecture in the 5G system. When the access device 12 adopts a centralized distributed architecture, it usually includes a central unit (CU) and at least two distributed units (DU). The central unit is provided with a protocol stack including a Packet Data Convergence Protocol (PDCP) layer, a Radio Link Control protocol (RLC) layer, and a Media Access Control (MAC) layer; a distributed unit is provided with a physical (PHY) layer protocol stack. The embodiments of the present disclosure do not limit the specific implementation of the access device 12.

A wireless connection may be established between an access device 12 and a UE 11 through a radio air interface. In different implementations, the radio air interface is a radio air interface based on the fourth generation mobile communication network technology (4G) standard; or, the radio air interface is a radio air interface based on the fifth generation mobile communication network technology (5G) standard, for example, the radio air interface is a new air interface; alternatively, the radio air interface may be a radio air interface based on the next generation mobile communication network technology standard of 5G.

As an example, the technical solutions provided in this application can be applied to a communication system using a dual connectivity technology, and the dual connectivity technology includes the following:

The first one is Multi-Radio Dual Connectivity (MR-DC).

MR-DC is a generalization of Universal Mobile Telecommunication System (UMTS) Terrestrial Radio Access (Intra-E-UTRA) dual connectivity, where a UE can use radio resources provided by two different resource scheduling units, and the resource scheduling units are located on two different New Generation Radio Access Network (NG-RAN) nodes, through non-ideal backhaul connection, one providing New Radio (NR) access and the other providing E-UTRA or NR access. A base station of a primary cell may be a Master Node (MN), and a base station of a secondary cell may be a Secondary Node (SN). The master node and the secondary node are connected through a network interface, and at least the master node is connected to a core network.

The second is MR-DC based on the Evolved Packet Core (EPC).

Referring to FIG. 2, an architecture diagram of an Evolved Universal Terrestrial Radio Access network (E-UTRA)-NR dual connectivity (EN-DC). The E-UTRAN supports MR-DC through E-UTRA-NR DC (EN-DC), where a UE is connected to a base station eNB acting as a Master Node (MN) and a base station en-gNB acting as a Secondary Node (SN). The base station eNB is connected to a core network EPC through a S1 interface and to the base station en-gNB through a X2 interface. The base station en-gNB may also be connected to the core network EPC through a S1-U interface, and may also be connected to other base station(s) en-gNB(s) through a X2-U interface. The core network equipment of the EPC may include: a Mobility Management Entity (MME) and/or a Service-Gateway (S-GW).

The third is MR-DC of a fifth generation mobile communication core network (5th Generation Core, 5GC).

The 5GC supports the following types of dual connectivity:

### 1) Dual Connectivity of E-UTRA-NR and NGEN-DC

The 5G radio access network NG-RAN supports NG-RAN E-UTRA-NR dual connectivity (NGEN-DC), where a UE is connected to ang-eNB acting as a Master Node (MN) and a gNB acting as a Secondary Node (SN). The base station ng-eNB is connected to the 5GC, and the base station gNB is connected to the base station ng-eNB through a Xn interface.

### 2) NR-E-UTRA Dual Connectivity

The NG-RAN supports NR-E-UTRA Dual Connectivity (NE-DC), where a UE is connected to a base station gNB acting as a Master Node (MN) and a base station ng-eNB acting as a Secondary Node (SN). The base station gNB is connected to the 5GC, and the base station ng-eNB is connected to the base station gNB through the Xn interface.

### 3) NR-NR Dual Connectivity

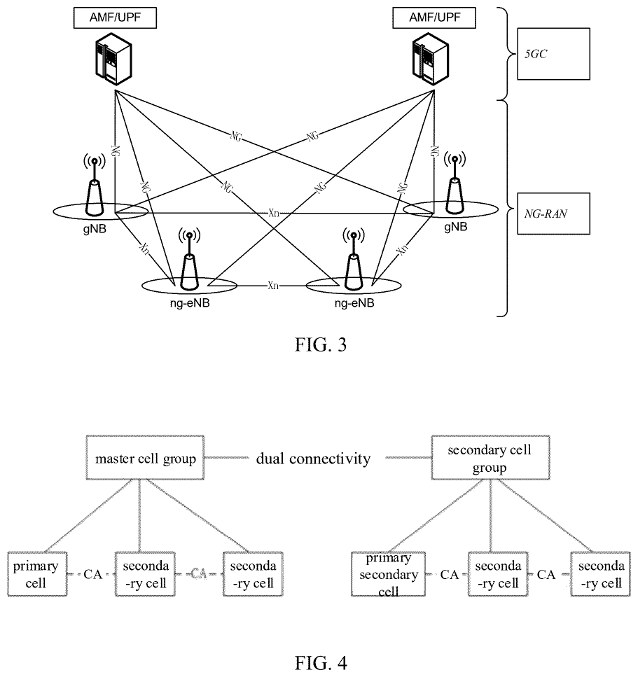

Referring to FIG. 3, a schematic diagram of the architecture of NR-DC is shown. The NG-RAN supports NR-NR dual connectivity (NR-DC), where a UE is connected to a base station gNB acting as a Master Node (MN) and another base station gNB acting as a Secondary Node (SN). The primary base station gNB is connected to the 5GC through a NG interface, the two base stations gNBs are connected through the Xn interface, and the secondary base station gNB may also be connected to the 5GC through a NG-U interface. In addition, NR-DC may also be used for a UE to access a single base station gNB, and the base station gNB acts as both a Master Node (MN) and a Secondary Node (SN), and a Master Cell Group (MCG) and a Secondary Cell Group (SCG) are configured at the same time.

The following provides relevant explanations or descriptions of the terms involved in this application:

Mobility actions include various actions related to a UE's serving cell update (or called change), for example, an action of the UE's primary cell change, an action of the UE's master cell group change, an action of the UE's secondary cell change operation, and/or an action of the UE's secondary cell group change.

A Primary Cell (Pcell) may be: a cell for a UE to initiate initial access.

A Master Cell Group (MCG) may be: a cell group including a primary cell. It should be noted that the master cell group may also include one or more secondary cells.

A Secondary Cell (Scell) may be a cell other than a Pcell. Secondary cell(s) may be divided into a Primary Secondary Cell (PScell), and the Primary Secondary Cell is a more important cell among secondary cells.

A Secondary Cell Group (SCG) includes: one or more secondary cells.

Usually, many pieces of control signaling for a UE are only sent on the primary cell or the primary secondary cell.

A Special (Primary) cell (sPcell) includes: a primary cell and/or a primary secondary cell.

As shown in FIG. 4, when a UE supports dual connectivity, the serving cell(s) of the UE may include a primary cell and a secondary cell; the serving cell group(s) of the UE may include: a master cell group and a secondary cell group.

A UE supports both MCG and SCG through dual connectivity. A UE supports both PCell and SCell of a MCG through Carrier Aggregation (CA); similarly, a UE supports both PSCell and SCell of a SCG through CA.

In an embodiment, in the 5G system, a UE may perform a mobility action based on a network preconfigured condition and a preconfigured cell or cell group corresponding to the condition. When the UE fulfills the preconfigured condition (e.g., a specific measurement event), the UE changes the serving cell or cell group to be the preconfigured cell or cell group.

A mobility procedure based on conditional triggering may include:
Conditional Handover (CHO);
conditional primary secondary cell or cell group addition (Conditional PSCell Addition, CPA);
conditional primary secondary cell or cell group (Conditional PSCell Change, CPC).

The UE may also change a special cell or special cell group configuration according to a network indication after a preconfigured condition is fulfilled. For example, the UE's Primary Cell (PCell) configuration is changed from candidate cell or candidate cell group configuration-1 to candidate cell or cell group configuration-2. The candidate cell is an alternative cell that the UE can access as a serving cell of the UE. The candidate cell group is an alternative cell group that the UE can access as a serving cell of the UE.

However, according to the CHO/CPC/CPA configuration, the UE must delete the CHO/CPC/CPA configuration when completing random access to a target primary cell or a target primary secondary cell. That is, the UE switches the serving cell to the target primary cell or the target primary secondary cell based on CHO/CPC or CPA through random access.

Therefore, if the network does not reconfigure and reinitialize CHO/CPC/CPA, the UE will not continue to perform CHO/CPC/CPA. This increases the delay of handover or Secondary Cell Group (SCG) change and increase signaling overhead. Especially, in a FR2 scenario, when Cell Group (CG) change occurs frequently, delay of handover or Secondary Cell Group (SCG) change is increased, and the signaling overhead is increased. A CG includes a MCG and a SCG.

Thus, selective activation of cell groups in MR-DC was proposed in the project of mobility enhancement. The selective activation of cell groups may also be called cell group activation. The configuration information of cell group activation may include: a configuration ID, a cell configuration or a target cell group configuration. Optionally, the configuration information of cell group activation may also include a trigger condition. The trigger condition may also be called an execution condition and/or an activation condition.

The configuration ID may be used to identify the corresponding configuration information.

The configuration of the cell and the cell group may include RRC reconfiguration information, etc., which may be used at least for a UE to access a cell or cell group.

The trigger condition may be a condition for the UE to activate a cell or cell group configuration. Before the UE activates the cell or cell group configuration, the cell or cell group configuration is in an inactivated state, and the UE does not use the inactivated cell or cell group configuration to access the network. After being activated by the UE, the cell or cell group configuration is in an activated state, and the UE uses the activated cell or cell group configuration to access the network. If the current status of the UE switches from fulfilling the activation condition to not fulfilling the activation condition, the UE can deactivate the cell or cell group configuration, and the cell or cell group configuration switches from the activated state to the deactivated state. The deactivated state is also an inactive state. For example, the UE determines whether the trigger condition is fulfilled by measuring a signal quality of the current serving cell and/or candidate cell.

In some embodiments, if no trigger condition is configured, the UE may perform the cell or cell group activation based on activation signaling sent by a network device. If deactivation signaling sent by the network device is received, the UE performs cell or cell group deactivation.

Under the selective activation configuration of the cell group, when the CG changes, the network does not need to reconfigure or reinitialize the corresponding cell group selective activation configuration, and the UE can still execute the cell group selective activation configuration subsequently. This can reduce the signaling overhead and the interruption duration of the cell change (CG change).

In the selective activation of the cell group, the network device may configure a cell group to be activated for the UE. The network device may subsequently activate or deactivate the cell group to be activated without re-providing the configuration of the cell group.

That is, in the selective activation of the cell group, after activating a new cell group configuration, the UE does not delete the corresponding cell group selective activation configuration.

In selective activation of a Secondary Cell Group (SCG), subsequent CPC can be continued after a Secondary Cell Group (SCG) change or addition occurs without RRC reconfiguration, and the CPC may be included in the selective activation of the SCG.

The selective activation of the cell group can change the serving cell group of the UE, and can continue to be executed according to the cell group selective activation configuration information, without the need for the network device to reconfigure or reinitialize the corresponding cell group selective activation configuration. Therefore, in the selective activation of the cell group, the network device can provide the UE with a cell group to be activated or a candidate cell group. The cell group to be activated can be activated or deactivated later without re-providing the configuration of the cell group.

In the selective activation of the cell group, the network device may provide a preconfigured candidate cell group or candidate cell to the UE device. The UE device may subsequently activate or deactivate the preconfigured candidate cell group or candidate cell according to a configuration (e.g., an activation message) sent by the network device or a corresponding activation event, without the need of re-providing the configuration information of the cell group. Alternatively, in the selective activation of a cell group, after activating a new cell or cell group, or applying a new cell configuration or cell group configuration, or accessing a new cell or cell group, the UE device does not delete the corresponding configuration information for the selective activation of the cell group.

When performing a cell change, the cell change may be performed through control signaling, for example: L1/L2-Triggered Mobility (LTM).

In the 5G system, the network device may provide multiple candidate cells or candidate cell groups to the UE. The network device may subsequently control the UE to perform change among multiple candidate cells or cell groups through L1 or L2 signaling, such as changing the candidate cell or candidate cell group from a candidate cell or cell group-1 to a candidate cell or cell group-2. L1 signaling may include Downlink Control Information (DCI), and L2 signaling may include MAC Control Element (CE) signaling.

One serving cell or cell group may correspond to one or more candidate cells or cell groups.

The mobility configuration of a cell may further include a mobility configuration of L3. The mobility configuration of L3 may include: a L3 configuration of mobility based on conditional triggering.

The L3 layer mobility configuration may also be configuration information for a UE's mobility action. However, in general, the configuration information may include a trigger condition for triggering the UE to perform the mobility action, which is also called L3 configuration of mobility based on conditional triggering.

The L3 configuration of mobility based on conditional triggering may include: a configuration ID which may be used to identify corresponding configuration information;
information of a trigger condition, where the trigger condition may be a condition for the UE to activate a cell or cell group configuration;
the configuration of the cell and the cell group may include RRC reconfiguration information, etc., which may be used at least for the UE to access the cell or cell group.

After executing the cell change (Cell Switch) or selective activation of a cell group, the UE may also retain the original LTM configuration of the candidate cell or candidate cell group or the L3 configuration of mobility based on conditional triggering.

The LTM only supports an intra-CU scenario, for LTM configured with a Master Cell Group (MCG) or a Primary Cell (PCell), or LTM configured with a Secondary Cell Group (SCG) or a Primary Secondary Cell (PSCell), if the network device configures the mobility of the inter-CU Master Cell Group (MCG) or Primary Cell (PCell), or the mobility of the inter-CU Secondary Cell Group (SCG) or Primary Secondary Cell (PSCell), the UE has a change in the inter-CU Master Cell Group (MCG) or Primary Cell (PCell), or a change in the Secondary Cell Group (SCG) or Primary Secondary Cell (PSCell), and the LTM configuration becomes invalid.

However, if the network device configures the mobility of the intra-CU Master Cell Group (MCG) or Primary Cell (PCell), or the mobility of the Secondary Cell Group (SCG) or Primary Secondary Cell (PSCell), the LTM configuration is valid. But, the UE cannot determine whether the mobility command configured by the network device is for intra-CU or inter-CU, and thus the UE cannot determine whether to retain or delete the LTM configuration.

Similarly, for the L3 configuration of mobility based on conditional triggering, only the selective activation of the Secondary Cell Group (SCG) or the Primary Secondary Cell (PSCell) is currently supported. Since the Secondary Cell Group (SCG) needs to be associated with the Master Node (MN), if the network configures the Master Cell Group (MCG) change for inter-MN, the original configuration of the selective activation of the Secondary Cell Group (SCG) becomes invalid. If the network configures the Master Cell Group (MCG) change for intra-MN, the configuration of the selective activation of the Secondary Cell Group (SCG) is valid. Similarly, the UE cannot determine whether the mobility command configured by the network device is for intra-MN or inter-MN, and thus the UE cannot determine whether the configuration of the selective activation of the Secondary Cell Group (SCG) needs to be retained or deleted.

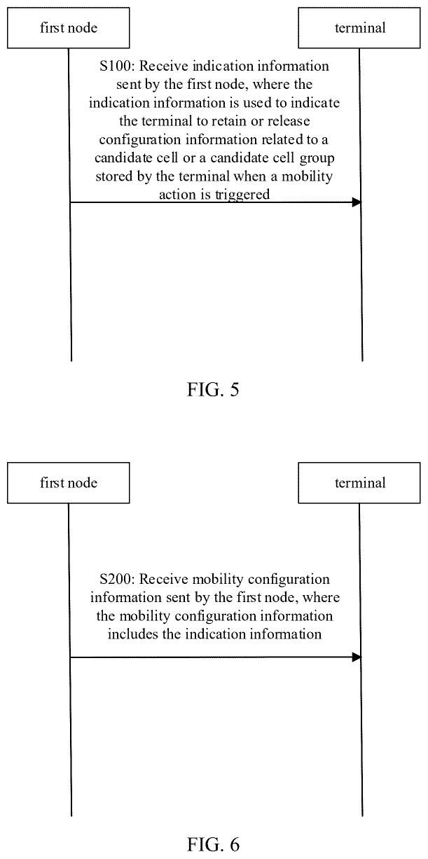

Referring to FIG. 5, a schematic diagram of an information processing method provided in an embodiment is shown. The method may be applied to a UE. The method includes:

In S100, indication information sent by a first node is received. The indication information is used to indicate the UE to retain or delete configuration information related to candidate cell(s) or candidate cell group(s) stored by the UE.

As an example, retaining or deleting the configuration information related to the candidate cell(s) or the candidate cell group(s) stored by the UE includes: retaining or deleting the configuration information related to all candidate cell(s) or candidate cell group(s) corresponding to a MCG and/or configuration information related to all candidate cell(s) or candidate cell group(s) corresponding to a SCG stored by the UE.

As an example, retaining or deleting the configuration information related to candidate cell(s) or candidate cell group(s) stored by the UE includes: retaining or deleting configuration information related to a part of candidate cell(s) or candidate cell group(s) corresponding to a MCG and/or configuration information related to a part of candidate cell(s) or candidate cell group(s) corresponding to a SCG stored by the UE. The configuration information related to a part of candidate cell(s) or candidate cell group(s) may be specified by the network, specified in a specification, or determined based on UE implementation.

The first node may include a base station. The base station may be a device such as an evolved node base station (eNB), or a node in a 5G system, such as a next generation node base station (gNB), or a Transmission and Reception Point (TRP), etc., or a network device in a subsequent evolved communication system.

In an embodiment, the deletion in various embodiments may be removal or release or clearing.

In an example, the first node may include a master node and/or a secondary node. The master node may be a base station corresponding to a primary cell or a master cell group, and the secondary node may be a base station corresponding to a primary secondary cell or a secondary cell group.

In an example, the UE is connected to the first node and may receive the indication information sent by the first node. The indication information may at least be generated by the first node and sent to the UE.

In an example, after receiving the indication information, the UE may determine to retain or delete the configuration information related to the candidate cell(s) or candidate cell group(s) stored by the UE according to the indication information.

In an example, condition(s) for triggering the UE to perform a mobility action includes (include) but not limited to one or more of the following:
a trigger condition included in or corresponding to mobility configuration information being fulfilled;
an instruction sent by a network device being received, where the instruction is used to indicate the UE to perform a mobility action.

As an example, the trigger condition included in the mobility configuration information may include: if a trigger condition for the cell selective configuration included in the mobility configuration is fulfilled, and/or, the trigger condition corresponding to the mobility configuration information being fulfilled may include: a handover condition for a cell conditional handover being fulfilled, the UE may automatically determine whether the mobility action is triggered. In other embodiments, the network device may indicate the UE to perform a mobility action through Layer 1 (L1) signaling, Layer 2 (L2) and/or Layer 3 (L3) signaling. Layer 1 may be a physical layer, and the signaling of the physical layer may at least include Downlink Control Information (DCI). Layer 2 signaling may at least include: Media Access Control (MAC) Control Element (CE), etc. Layer 3 signaling may include: Radio Resource Control (RRC) signaling.

In an embodiment, the mobility action(s) performed by the UE includes (include) various actions related to the UE's serving cell update (or change). As an example, the mobility action(s) performed by the UE include one or more of the following: an operation related to the UE's primary cell change, an action related to the UE's master cell group change, an action related to the UE's secondary cell change, an action related to the UE's secondary cell group change.

As described above, the UE retains or deletes the stored configuration information related to the candidate cell(s) or candidate cell group(s) according to the indication information. It can be understood that after the UE triggers a mobility action, it indicates that the candidate cell(s) or candidate cell group(s) of the UE may change, and the configuration information related to the candidate cell(s) or candidate cell group(s) currently stored by the UE may no longer be applicable or may be applicable. Thus, the UE receives the indication information sent by the first node, and the indication information can be used by the UE to determine whether it is needed to delete the configuration information related to the candidate cell(s) or candidate cell group(s) currently stored by the UE itself. In this way, the method can avoid a case in related art where the UE does not receive the indication information and cannot know whether it is needed to delete the configuration information related to the candidate cell(s) or candidate cell group(s) and thus the UE may mistakenly retain or delete the configuration information related to the candidate cell(s) or candidate cell group(s). For example, when the UE mistakenly retains the configuration information related to the candidate cell(s) or candidate cell group(s) that is no longer applicable, after the UE performs the mobility action, use of the wrong configuration information related to the candidate cell(s) or candidate cell group(s) causes a phenomenon of a failure in accessing a serving cell or a serving cell group or poor communication quality after access. The present application clarifies the configuration information related to the candidate cell(s) or candidate cell group(s) which is no longer applicable through the indication information, which is conducive to improving the access success rate and/or communication quality. For another example, when the UE mistakenly removes the applicable configuration information related to the candidate cell(s) or candidate cell group(s), it is needed to reconfigure the applicable configuration information related to the candidate cell(s) or candidate cell group(s).

In an embodiment, the indication information is used to indicate the UE to retain or delete the configuration information under a preset condition. The preset condition includes during a procedure of performing the mobility action, after execution of the mobility action, or before the execution of the mobility action.

The indication information is used to indicate that the configuration information may be retained or deleted according to the indication information during the procedure of the UE performing the mobility action; or
the indication information is used to indicate the UE to retain or delete the configuration information after the UE performs the mobility action; or
the indication information is used to indicate that before the UE performs the mobility action, the UE determines to perform the mobility action, and the UE retains or deletes the configuration information according to the indication information.

In an embodiment, the indication information may be character-type indication information, such as 0 and 1, etc. The indication information may also be explicit indication information or implicit indication information.

In an embodiment, referring to FIG. 6, a schematic diagram of an information processing method provided in an embodiment is shown. The method may be applied to a UE. The method includes:

In S200, mobility configuration information sent by a first node is received. The mobility configuration information includes the indication information.

In an embodiment, the configuration information related to the candidate cell(s) or the candidate cell group(s) includes:
L1/L2-Triggered Mobility (LTM) configuration information of the candidate cell(s) or candidate cell group(s); and/or
selective activation configuration information of the candidate cell(s) or candidate cell group(s).

As an example, the mobility configuration information is L3 configuration information.

The L1 and/or L2-triggered mobility (L1/L2-Triggered Motility, LTM) configuration information may be configuration information activated through L1 and/or L2 instruction. Cell selective activation configuration information may be configuration information that is activated by the UE when an activation condition is fulfilled.

The selective activation configuration information may include at least one of the following:
a configuration information identity, including a configuration ID;
condition information, including an activation condition and a trigger condition;
configuration information of a candidate cell or candidate cell group, including the configuration information of a cell group or cell to be activated. The cell group or cell to be activated becomes a target cell or target cell group after being activated.

Different mobility configuration information may have different configuration information identities. For example, any two of L1 mobility configuration information, L2 mobility configuration information, and L3 mobility configuration information may have different configuration information identities.

The mobility configuration information corresponding to different candidate cells or cell groups may have different configuration information identities. For example: the mobility configuration information corresponding to a first candidate cell or cell group has a configuration ID1, and the mobility configuration information corresponding to a second candidate cell or cell group has a configuration ID2.

The condition information indicates a trigger condition. When the trigger condition is fulfilled, it is considered needed to trigger the mobility action of the UE. The trigger condition may include one or more of conditional trigger event A3, A4 or A5.

In an embodiment, after the UE triggers a mobility action, the UE accesses a target cell, and the target cell or target cell group is: a serving cell and/or serving cell group accessed after the UE's mobility action.

As an example, the mobility configuration information corresponding to the mobility action may be preconfigured by the network device for the UE, each mobility configuration information corresponds to a cell or a cell group, the mobility configuration information may include a trigger condition, and the target cell or target cell group is one or more of the cells or cell groups corresponding to the trigger condition fulfilled by the UE. Alternatively, the network indicates activation of a certain mobility configuration, and the target cell or target cell group is the cell or cell group corresponding to the mobility configuration to be activated as indicated by the network.

In an embodiment, the mobility action is used for a primary cell change or a master cell group change, and the indication information is used to indicate the UE to delete configuration information related to a candidate primary cell or a candidate master cell group stored by the UE, and delete configuration information related to a candidate primary secondary cell or a candidate secondary cell group.

After the mobility action is triggered, if the mobility action is used for the primary cell change or the master cell group change, the primary cell or the master cell group changes. In the case where the primary cell or the master cell group changes, the indication information indicates the UE to delete the configuration information related to the candidate primary cell or the candidate master cell group stored by the UE. After the candidate primary cell or the candidate master cell group changes, the candidate secondary cell or the candidate secondary cell group corresponding to the candidate primary cell or the candidate master cell group also changes, and thus the indication information also indicates the UE to delete the configuration information related to the candidate secondary cell or the candidate secondary cell group.

In an embodiment, if the mobility action is an action of the UE's primary cell switch or update or change, the configuration information of the current primary cell is not deleted, and the UE continues to store or use the configuration information of the current primary cell (that is, the source primary cell), the target primary cell after the mobility action may mistakenly refer to the configuration information of the source primary cell, thereby causing the configuration information of the target primary cell to be applied mistakenly.

As an example, if the target cell is the primary cell which the UE accesses after performing the mobility action, if the previous configuration information of the source primary cell is not deleted, the UE may mistakenly consider the configuration information of the source primary cell to be the configuration information of the target primary cell and use it.

After the UE performs the mobility action and before applying the configuration information of the target cell or the target cell group, it is needed to delete a part or all of the configuration information of the current cell and/or the current cell group, so as to reduce errors in applying the configuration information of the target cell and/or the target cell group.

In an embodiment, the mobility action is used for the primary cell change or the master cell group change, the master node which the UE accesses changes, and the master node which the UE accesses is changed from a Source-Master Node (S-MN) of a source primary cell or a source master cell group to a Target-Master Node (T-MN) of a target primary cell or a target master cell group. The target primary cell or the target master cell group is different from the source primary cell or the source master cell group, and the indication information is used to indicate the UE to delete the configuration information related to the source primary cell or the source master cell group stored by the UE, and delete the configuration information related to a source secondary cell or a source secondary cell group.

In an embodiment, the mobility action is used for a primary secondary cell change or a secondary cell group change, and the indication information is used to indicate the UE to delete the configuration information related to a candidate secondary cell or a candidate secondary cell group stored by the UE.

After the mobility action is triggered, if the primary secondary cell or the secondary cell group changes, a secondary node which the UE accesses changes. In this case, the indication information indicates the UE to delete the configuration information related to a candidate secondary cell or a candidate secondary cell group stored by the UE. Triggering the mobility action for the primary secondary cell or the secondary cell group indicates that a primary secondary cell or a secondary cell group of the UE will be switched to a target primary secondary cell or secondary cell group. In order to reduce the interference of the configuration information of the current primary secondary cell or the current secondary cell group on application of the configuration information of the target cell or the target cell group, a part and/or all of the configuration information of the current primary secondary cell or the current secondary cell group is deleted.

If the mobility action is an action of the UE's primary cell switch or update or change, and the configuration information of the current secondary cell is not deleted, the UE continues to store or use the configuration information of the current secondary cell (that is, the source secondary cell), a target secondary cell after the mobility action may mistakenly refer to the configuration information of the source secondary cell, thereby causing errors in applying configuration information of the target secondary cell.

As an example, if the target cell is a secondary cell which the UE accesses after performing a mobility action, if the configuration information of the previous source secondary cell is not deleted, the UE may mistakenly consider the configuration information of the source secondary cell to be the configuration information of the target secondary cell and use it.

After the UE performs the mobility action and before applying the configuration information of the target cell or the target cell group, it is needed to delete a part or all of the configuration information of the current cell and/or the current cell group, so as to reduce errors in applying the configuration information of the target cell and/or the target cell group.

In this case, the primary cell or master cell group may change or may not change, the Master Node (MN) of the primary cell or master cell group may change or may not change, and the Source-Master Node (S-MN) including the source-primary cell or source-master cell group may change or may not change.

In an embodiment, the candidate primary cell(s) includes (include) a source secondary cell and a target secondary cell, and the candidate master cell group(s) includes (include) a source secondary cell group and a target secondary cell group. Since the secondary cell or secondary cell group changes, the secondary node connected to the UE also changes, and the mobility action is used for the primary secondary cell change or the secondary cell group change. The Target-Secondary Node (T-SN) of the target secondary cell or target secondary cell group is different from the Source-Secondary Node (S-SN) of the source secondary cell or source secondary cell group, and the secondary node which the UE accesses is changed from the Source-Secondary Node (S-SN) of the source secondary cell or source secondary cell group to the Target-Secondary Node (T-SN) of the target secondary cell or target secondary cell group. Therefore, the indication information indicates the UE to delete the configuration information related to the primary secondary cell or secondary cell group, and thus the indication information indicates the UE to delete the configuration information related to the source secondary cell or source secondary cell group.

In an embodiment, the mobility action is used for the primary cell change or the master cell group change, and the indication information is used to indicate the UE to retain the configuration information related to the candidate primary cell or the candidate master cell group stored by the UE, and to retain the configuration information related to the candidate secondary cell or the candidate secondary cell group stored by the UE.

After the mobility action is triggered, if the primary cell or the master cell group does not change, in this case, the indication information indicates the UE to retain the configuration information related to the candidate primary cell or the candidate master cell group. If the mobility action is an action of not switching or not updating or not changing the primary cell of the UE, and the configuration information of the current secondary cell is retained, the UE continues to store or use the configuration information of the current primary cell (that is, the source primary cell), the target primary cell after the mobility action will refer to the configuration information of the source primary cell, and there is no need to re-obtain new configuration information.

As an example, if the target cell is a primary cell which the UE accesses after performing a mobility action, if the configuration information of the previous source primary cell is deleted, the UE needs to re-obtain the configuration information of the primary cell.

After the UE performs the mobility action and before applying the configuration information of the target cell or the target cell group, it is needed to retain a part or all of the configuration information of the current cell and/or the current cell group, thereby reducing the procedure of re-obtaining the configuration information of the target cell and/or the target cell group.

In an embodiment, after the mobility action is triggered, if the primary cell or the master cell group does not change, the target primary cell or the target master cell group is the same as the source primary cell or the source master cell group. In the case where the primary cell or the master cell group does not change, the master node which the UE accesses does not change, and the master node which the UE accesses is still the Source-Master Node (S-MN) of the source primary cell or the source master cell group, and the Target-Master Node (T-MN) of the target primary cell or the target master cell group is the same as the Source-Master Node (S-MN) of the source primary cell or the source master cell group. In this case, the indication information indicates the UE to retain the configuration information related to the candidate primary cell or the candidate master cell group.

In another embodiment, the Target-Master Node (T-MN) of the target primary cell or the target master cell group is the same as the Source-Master Node (S-MN) of the source primary cell or the source master cell group, and the Target-Secondary Node (T-SN) of the target secondary cell or the target secondary cell group is the same as the Source-Secondary Node (S-SN) of the candidate secondary cell or the candidate secondary cell group, and the indication information is also used to indicate the UE to retain the configuration information related to the candidate secondary cell or the candidate secondary cell group.

In an embodiment, when the Target-Master Node (T-MN) of the target primary cell or the target master cell group is the same as the Source-Master Node (S-MN) of the source primary cell or the source master cell group, the primary cell does not change, and the source primary cell which the UE accesses does not change. If the source secondary cell or the source secondary cell group corresponding to the source primary cell or the source master cell group changes, and the Target-Secondary Node (T-SN) of the target secondary cell or the target secondary cell group is different from the Source-Secondary Node (S-SN) of the source secondary cell or the source secondary cell group, the indication information indicates the UE to delete the configuration information related to the source secondary cell or the source secondary cell group.

In an embodiment, the mobility action is used for the primary secondary cell or the secondary cell group, and the indication information is used to indicate the UE to retain the configuration information related to the candidate secondary cell or the candidate secondary cell group stored by the UE.

After the mobility action is triggered, if the primary secondary cell or the secondary cell group does not change, the indication information is used to indicate the UE to retain the configuration information related to the candidate secondary cell or the candidate secondary cell group stored by the UE.

If the mobility action is an action of not switching or not updating or not changing the secondary cell of the UE and the configuration information of the current secondary cell is retained, the UE continues to store or use the configuration information of the current secondary cell (that is, the source secondary cell), the target secondary cell after the mobility action will refer to the configuration information of the source secondary cell, and there is no need to re-obtain new configuration information.

As an example, if the target cell is a primary cell which the UE accesses after performing a mobility action, if the configuration information of the previous source secondary cell is deleted, the UE needs to re-obtain the configuration information of the secondary cell.

After the UE performs the mobility action and before applying the configuration information of the target cell or the target cell group, it is needed to retain a part or all of the configuration information of the current cell and/or the current cell group, thereby reducing the procedure of re-obtaining the configuration information of the target secondary cell and/or the target secondary cell group.

In an embodiment, the candidate primary cell(s) includes (include) a source secondary cell and a target secondary cell, and the candidate master cell group(s) includes (include) a source secondary cell group and a target secondary cell group. The Target-Secondary Node (T-SN) of the target secondary cell or the target secondary cell group is the same as the Source-Secondary Node (S-SN) of the source secondary cell or the source secondary cell group. If the Source-Secondary Node (S-SN) of the source secondary cell or the source secondary cell group does not change, it means that the secondary cell or the secondary cell group does not change. The secondary node which the UE accesses does not change. In this case, the indication information indicates the UE to retain the configuration information related to the secondary primary cell or the secondary master cell group stored by the UE.

In an embodiment, the mobility action is used for the primary cell change or the master cell group change, and the indication information is generated by the Target-Master Node (T-MN).

In this case, the indication information is generated by the Target-Master Node (T-MN) of the target cell or target cell group, and the first node receives the indication information sent by the Target-Master Node (T-MN) to the first node. The Target-Master Node (T-MN) is different from the first node, and the first node may be a Source-Master Node (S-MN) or a Source-Secondary Node (S-SN).

For example, the indication information is generated by the Target-Master Node (T-MN) and included in a handover request response message sent by the Target-Master Node (T-MN) to the Source-Master Node (S-MN).

For another example, the indication information is included in a handover command sent by the Target-Master Node (T-MN) to the Source-Master Node (S-MN).

As an example, the indication information is included in a handover command message, and the handover command message may be handoverCommandMessage.

As an example, the indication information is included in a command message field. The command message includes the command message field. The command message field may be handoverCommand.

As an example, the indication information is included in a target cell radio resource reconfiguration RRCReconfiguration message, and the radio resource reconfiguration RRCReconfiguration message includes a handover command message handoverCommandMessage.

After the Source-Master Node (S-MN) receives the handover command sent by the Target-Master Node (T-MN), the Source-Master Node (S-MN) sends the transparent Container: RRCReconfiguration generated by the Target-Master Node (T-MN) in the handover command to the UE to trigger Uu handover, such as the Master Cell Group (MCG) change or the Primary Cell (PCell) change.

In an embodiment, the mobility action is used for the primary cell change or the master cell group change, and the indication information is generated by the Source-Master Node (S-MN).

In this case, the indication information is generated by a Source-Master Node (S-MN) of a source primary cell or a source master cell group, and the first node sends the indication information to the UE.

For example, when the Source-Master Node (S-MN) sends a Uu interface handover command message to the UE to trigger the Uu handover, the Source-Master Node (S-MN) carries the indication information. The handover command may be represented by a radio resource reconfiguration RRCReconfiguration message.

For example, a message including a handover command from the Target-Master Node (T-MN) and indication information generated by the Source-Master Node (S-MN) is sent to the UE, for example, an RRC message is sent to the UE.

As an example, a first radio resource reconfiguration RRCReconfiguration message includes a second radio resource reconfiguration RRCReconfiguration message and indication information, and the Source-Master Node (S-MN) sends the first radio resource reconfiguration RRCReconfiguration to the UE, where the second radio resource reconfiguration RRCReconfiguration message is forwarded by the Target-Master Node (T-MN) to the Source-Master Node (S-MN).

As an example, the Source-Master Node (S-MN) sends the indication information to the UE before sending the Uu interface handover command to the UE to trigger the Uu handover. The handover command is a type of radio resource reconfiguration RRCReconfiguration message.

In an embodiment, the mobility action is used for the primary secondary cell change or the secondary cell group change, and the indication information is generated by the Target-Secondary Node (T-SN).

In this case, the indication information is generated by the Target-Secondary Node (T-SN), and the first node receives the indication information sent by the Target-Secondary Node (T-SN) to the first node. The Target-Secondary Node (T-SN) is different from the first node, and the first node may be a Source-Master Node (S-MN) or a Source-Secondary Node (S-SN).

As an example, the indication information is applicable to a Secondary Cell Group (SCG) change initiated by a Master Node (MN) and a Secondary Cell Group (SCG) change initiated by a Secondary Node (SN).

The initiation is included in an addition request response message sent by the T-SN to the MN. For example, the indication information is included in CG-Config sent by the T-SN to the S-MN.

As an example, it is included in a target Secondary Cell Group (SCG) configuration (scg-CellGroupConfig).

As an example, it is included in a target cell configuration RRCReconfiguration corresponding to scg-CellGroupConfig.

As an example, after the Master Node (MN) receives the target Secondary Cell Group (SCG) configuration sent by the Target-Secondary Node (T-SN), the Master Node (MN) includes, in the radio resource reconfiguration RRCReconfiguration message generated by the MN, the node radio resource reconfiguration RRCReconfiguration message (SN RRCReconfiguration) including the indication information generated by the Target-Secondary Node (T-SN) in the target Secondary Cell Group (SCG) configuration, and sends it to the UE, triggering the UE to apply the target Secondary Cell Group (SCG) configuration, such as the Secondary Cell Group (SCG) change or the Primary Secondary Cell (PSCell) change.

As an example, the radio resource reconfiguration RRCReconfiguration message from the Secondary Node (SN) may be configured through a mrdc-SecondaryCellGroup domain, and thus the mrdc-SecondaryCellGroup includes the radio resource reconfiguration RRCReconfiguration message generated by the Secondary Node (SN). The RRC message may include the indication information. For example, the RRC message may only include the domain(s) secondaryCellGroup, otherConfig, conditionalReconfiguration, measConfig, bap-Config, IAB-IP-AddressConfigurationList, and a domain corresponding to the indication information.

In an embodiment, the mobility action is used for the primary secondary cell change or the secondary cell group change, and the indication information is generated by a Source-Secondary Node (S-SN).

As an example, the indication information is applicable to a Secondary Cell Group (SCG) change initiated by a Secondary Node (SN).

The Source-Secondary Node (S-SN) initiates the Secondary Cell Group (SCG) change process by sending a Secondary Node (SN) change request message to the Target-Master Node (T-MN), where the indication information may be carried in the Source-Secondary Node (S-SN) change request message. Then, the Master Node (MN) sends the indication information sent by the Source-Secondary Node (S-SN) to the Master Node (MN) to the UE, and the UE receives the indication information.

As an example, the Source-Secondary Node (S-SN) sends the indication information to the UE, and the UE determines whether to retain the configuration of LTM or selective activation of the Secondary Cell Group (SCG) according to the indication information.

In an embodiment, the mobility action is used for a secondary cell change, and the indication information is generated by a Master Node (MN) or a Secondary Node (SN).

As an example, it is applicable to a Secondary Cell Group (SCG) change initiated by the Master Node (MN) and a Secondary Cell Group (SCG) change initiated by the Secondary Node (SN).

When the Master Node (MN) triggers the UE to initiate the Secondary Cell Group (SCG) change, the MN carries the indication information. For example, when a MN RRCReconfiguration message including SN RRCReconfiguration is sent to the UE, the indication information is carried.

As an example, the first node sends, to the UE, a message including a target Secondary Cell Group (SCG) configuration (such as SN RRCReconfiguration) from the Target-Secondary Node (T-SN) and indication information generated by the Master Node (MN) (for example, the RRC message of the Master Node (MN) is sent to the UE), and the UE receives the indication information.

As an example, the Master Node (MN) radio resource control reconfiguration RRCReconfiguration message includes the Secondary Node (SN) radio resource control reconfiguration RRCReconfiguration message and the indication information, and the Master Node (MN) sends the Master Node (MN) radio resource control reconfiguration RRCReconfiguration to the UE, and the UE receives the indication information. The Secondary Node (SN) radio resource control reconfiguration RRCReconfiguration message is forwarded by the Source-Secondary Node (S-SN) to the Master Node (MN), and corresponds to the configuration information of the target Secondary Cell Group (SCG).

For example, a mrdc-SecondaryCellGroupConfig domain in the radio resource control reconfiguration RRCReconfiguration message generated by the Master Node (MN) includes the indication information and a mrdc-SecondaryCellGroup domain for configuring the SN RRCReconfiguration.

As an example, before triggering the UE to initiate a Secondary Cell Group (SCG) change, the Master Node (MN) sends indication information to the UE, for example, sending a MN RRCReconfiguration message including SN RRCReconfiguration to the UE.

In an embodiment, the mobility action is used for the primary cell change or the master cell group change, and the first node is a Source-Master Node (S-MN) or a Source-Secondary Node (S-SN) of a primary secondary cell; or

the mobility action is used for the primary secondary cell change or the secondary cell group change, and the first node is a Master Node (MN).

In an embodiment, only the Source-Master Node (S-MN) or the current Master Node (MN) can directly send information to the UE, and the Target-Master Node (T-MN) or the Secondary Node (SN) cannot send the indication information to the UE at the current moment.

In an embodiment, the indication information is included in a radio resource reconfiguration RRCReconfiguration message.

In an embodiment, the RRCReconfiguration message includes: a handover command message, used to indicate a cell handover or cell group handover for the UE.

In an embodiment, receiving the indication information sent by the first node includes:

receiving a radio resource control reconfiguration RRCReconfiguration message sent by the Source-Master Node (S-MN), wherein the mobility action is used for the primary cell change or the master cell group change, wherein the radio resource control reconfiguration RRCReconfiguration message includes the indication information.

The first node in this embodiment is the Source-Master Node (S-MN), the indication information is sent by the Source-Master Node (S-MN), and the UE receives the radio resource control reconfiguration RRCReconfiguration message sent by the Source-Master Node (S-MN). The radio resource control reconfiguration RRCReconfiguration message includes the indication information, and the UE can receive the indication information after receiving the radio resource control reconfiguration RRCReconfiguration message.

In an embodiment, the indication information corresponds to a preset field;

the indication information including the preset field is used to indicate retaining the configuration information related to the candidate cell or the candidate cell group; the indication information not including the preset field is used to indicate deleting the configuration information related to the candidate cell or the candidate cell group.

In an embodiment, the indication information corresponds to a preset field;

the indication information including the preset field is used to indicate deleting the configuration information related to the candidate cell or the candidate cell group; the indication information not including the preset field is used to indicate retaining the configuration information related to the candidate cell or the candidate cell group.

In an embodiment, the indication information corresponds to a preset field;
a value of the indication information being a first value is used to indicate deleting the configuration information related to the candidate cell or the candidate cell group;
the value of the preset field included in the indication information being a second value is used to indicate retaining the configuration information related to the candidate cell or the candidate cell group.

In an embodiment, receiving the indication information sent by the first node includes:

receiving a radio resource control reconfiguration RRCReconfiguration message sent by the Source-Secondary Node (S-SN), wherein the mobility action is used for the primary secondary cell change or the secondary cell group change, wherein the radio resource control reconfiguration RRCReconfiguration message includes the indication information.

The indication information in this embodiment is sent by the Source-Secondary Node (S-SN), and the UE receives the radio resource control reconfiguration RRCReconfiguration message sent by the Source-Primary Secondary Node (S-SN). The radio resource control reconfiguration RRCReconfiguration message includes the indication information. After receiving the radio resource control reconfiguration RRCReconfiguration message, the UE can receive the indication information.

In an embodiment, receiving the indication information sent by the first node includes:

receiving a radio resource control reconfiguration RRCReconfiguration message sent by the Master Node (MN), wherein the mobility action is used for the primary secondary cell change or the secondary cell group change, wherein the radio resource control reconfiguration RRCReconfiguration message includes the indication information.

The indication information in this embodiment is sent by the Master Node (MN), and the UE receives the radio resource control reconfiguration RRCReconfiguration message sent by the Master Node (MN). The radio resource control reconfiguration RRCReconfiguration message includes the indication information. After receiving the radio resource control reconfiguration RRCReconfiguration message, the UE can receive the indication information.

In an embodiment, the radio resource control reconfiguration RRCReconfiguration message includes a handover command.

In an embodiment, the indication information is used to indicate the UE to delete or retain the LTM configuration or selective activation configuration stored by the UE after performing a mobility action (e.g., a Secondary Cell Group (SCG) change). The UE determines whether to retain or delete the stored LTM configuration based on the indication information, such as the candidate cell configuration corresponding to the LTM, for example, a configuration of the LTM of a Master Cell Group (MCG) or a Primary Cell (PCell) (e.g., a candidate MCG configuration), a configuration of the LTM of a Secondary Cell Group (SCG) or a Primary Secondary Cell (PSCell) (e.g., a candidate SCG configuration). And/or, the UE determines whether to retain or release the conditional mobility configuration of selective activation based on the indication information.

In an embodiment, the indication information corresponds to a preset field;

whether the message, in which the indication information is included, includes the preset field or the content of the preset field is used to indicate releasing or retaining the configuration information related to the candidate cell or the candidate cell group.

In an embodiment, the message, in which the indication information is included, including the preset field is used to indicate releasing the configuration information related to the candidate cell or the candidate cell group, and the message, in which the indication information is included, not including the preset field is used to indicate retaining the configuration information related to the candidate cell or the candidate cell group.

Alternatively, in an embodiment, the message, in which the indication information is included, including the preset field is used to indicate retaining the configuration information related to the candidate cell or the candidate cell group, and the message, in which the indication information is included, not including the preset field is used to indicate releasing the configuration information related to the candidate cell or the candidate cell group.

In an embodiment, the indication information is included in a radio resource control reconfiguration RRCReconfiguration message. Whether the radio resource control reconfiguration RRCReconfiguration message includes the preset field is used to indicate whether to delete or retain the configuration information related to the candidate cell or the candidate cell group.

For example, if the first node sends the indication information or the mobility trigger command information of a response includes the indication information, the UE retains the stored LTM and/or selective activation configuration. If the indication information is not included, the UE deletes the stored LTM and/or selective activation configuration. For another example, if the first node sends the indication information or the mobility trigger command message of the response includes the indication information, the UE deletes the stored LTM and/or selective activation configuration. If the indication information is not included, the UE retains the stored LTM and/or selective activation configuration.

In an embodiment, the radio resource control reconfiguration RRCReconfiguration message including the preset field is used to indicate deleting the configuration information related to the candidate cell or the candidate cell group. The radio resource control reconfiguration RRCReconfiguration message not including the preset field is used to indicate retaining the configuration information related to the candidate cell or the candidate cell group.

In an embodiment, the radio resource control reconfiguration RRCReconfiguration message including the preset field is used to indicate retaining the configuration information related to the candidate cell or candidate cell group. The radio resource control reconfiguration RRCReconfiguration message not including the preset field is used to indicate deleting the configuration information related to the candidate cell or candidate cell group.

In an embodiment, the value of the preset field included in the radio resource control reconfiguration RRCReconfiguration message is used to indicate to delete or retain the configuration information related to the candidate cell or the candidate cell group.

The preset field may be determined according to actual usage requirements and is not limited here.

In an embodiment, the value of the preset field included in the message including the indication information being a first value is used to indicate releasing the configuration information related to the candidate cell or the candidate cell group; the value of the preset field included in the message including the indication information being a second value is used to indicate retaining the configuration information related to the candidate cell or the candidate cell group; or

the value of the preset field included in the message including the indication information being a second value is used to indicate releasing the configuration information related to the candidate cell or the candidate cell group; the value of the preset field included in the message including the indication information being a first value is used to indicate retaining the configuration information related to the candidate cell or the candidate cell group.

As an example, the indication information is included in a radio resource control reconfiguration RRCReconfiguration message.

In an embodiment, the value of the preset field included in the radio resource control reconfiguration RRCReconfiguration message being a first value is used to indicate deleting the configuration information related to the candidate cell or the candidate cell group. The value of the preset field included in the radio resource control reconfiguration RRCReconfiguration message being a second value is used to indicate retaining the configuration information related to the candidate cell or the candidate cell group.

In an embodiment, the value of the preset field included in the radio resource control reconfiguration RRCReconfiguration message being a second value is used to indicate deleting the configuration information related to the candidate cell or the candidate cell group. The value of the preset field included in the radio resource control reconfiguration RRCReconfiguration message being a first value is used to indicate retaining the configuration information related to the candidate cell or the candidate cell group.

As an example, if the first node sends the indication information or the mobility trigger command message of a response includes the indication information and the indication information is a first specific value, the UE deletes the stored LTM and/or selective activation configuration; if the indication information is a second specific value, the UE retains the stored LTM and/or selective activation configuration.

In an embodiment, in response to the UE receiving the radio resource control reconfiguration RRCReconfiguration message sent by the first node, the radio resource control reconfiguration RRCReconfiguration includes a MCG configuration carrying a synchronization reconfiguration. The radio resource control reconfiguration RRCReconfiguration message includes a handover command.

If the UE receives the radio resource control reconfiguration RRCReconfiguration message forwarded by the Source-Master Node (S-MN) from the Target-Master Node (T-MN) and the RRCReconfiguration message includes the indication information or the indication information is a specific value, the UE deletes the LTM candidate cell configuration, deletes the candidate MCG configuration and/or the candidate SCG configuration; otherwise, the UE retains the LTM candidate cell configuration, retains the candidate MCG configuration and/or the candidate SCG configuration.

If the UE receives the radio resource control reconfiguration RRCReconfiguration message sent by the Source-Master Node (S-MN) and the RRCReconfiguration message includes the indication information or a value of the indication information is a specific value or the UE receives the indication information sent by the Source-Master Node (S-MN), the UE deletes the LTM candidate cell configuration, deletes the candidate MCG configuration and/or the candidate SCG configuration; otherwise, the UE retains the LTM candidate cell configuration, retains the candidate MCG configuration and/or the candidate SCG configuration.

In an embodiment, in response to that the radio resource control reconfiguration RRCReconfiguration message sent by the Source-Master Node (S-MN) and received by the UE or the radio resource control reconfiguration RRCReconfiguration message of the Target-Master Node (T-MN) forwarded by the Source-Master Node (S-MN) includes the indication information or the indication information is a specific value, and the UE handover is successful (for example, the UE successfully accesses the target cell PCell), the UE deletes the LTM candidate cell configuration, deletes the candidate MCG configuration and/or the candidate SCG configuration; otherwise, the UE retains the LTM candidate cell configuration, retains the candidate MCG configuration and/or the candidate SCG configuration.

In an embodiment, in response to the UE receiving a message sent by the network that triggers a Secondary Cell Group (SCG) change, for example, receiving a radio resource control reconfiguration RRCReconfiguration message sent by the first node, the radio resource control reconfiguration RRCReconfiguration includes a SCG configuration carrying a synchronization reconfiguration, including the indication information.

In an embodiment, if the UE receives a Secondary Node (SN) radio resource control reconfiguration RRCReconfiguration message from the Target-Secondary Node (T-SN) forwarded by the Master Node (MN), and the SN RRCReconfiguration message includes the indication information or the indication information is a specific value, the UE deletes the LTM candidate cell configuration and deletes the candidate SCG configuration; otherwise, the UE retains the LTM candidate cell configuration and retains the candidate SCG configuration.

In an embodiment, if the UE receives a Master Node (MN) radio resource control reconfiguration RRCReconfiguration message sent by the Master Node (MN), and the MN RRCReconfiguration message includes the Secondary Node (SN) radio resource control reconfiguration and also includes the indication information or the indication information is a specific value, or the UE receives the indication information sent by the Master Node (MN), the UE deletes the LTM candidate cell configuration and deletes the candidate SCG configuration; otherwise, the UE retains the LTM candidate cell configuration and retains the candidate SCG configuration.

In an embodiment, the UE receives the indication information sent by the Source-Secondary Node (S-SN), the UE deletes the candidate target configuration of the LTM and deletes the candidate SCG configuration; otherwise, the UE retains the LTM candidate cell configuration and retains the candidate SCG configuration.

In an embodiment, in response to that a radio resource control reconfiguration RRCReconfiguration message sent by the Master Node (MN) and received by the UE or the radio resource control reconfiguration RRCReconfiguration message of the Target-Master Node (T-MN) forwarded by the Master Node (MN) includes the indication information or the indication information is a specific value, or the UE receives the indication information sent by the Master Node (MN) or the Target-Secondary Node (T-SN) and the UE successfully performs the Secondary Cell Group (SCG) change (for example, the UE successfully accesses the target cell PSCell), the UE deletes the LTM candidate cell configuration and deletes the candidate SCG configuration; otherwise, the UE retains the LTM candidate cell configuration and retains the candidate SCG configuration.

In an embodiment, deleting the candidate target configuration of the LTM means deleting all candidate target configuration(s) stored in the UE, for example, all candidate MCG configuration(s) and/or all candidate SCG configuration(s), rather than configuration(s) of a specific candidate MCG or candidate SCG.

In an embodiment, the UE receives one or more pieces of configuration information of condition-based mobility sent by the first node, where the conditional mobility configuration information is used for SCG selective activation, and the UE receives and stores the configuration(s).

In an embodiment, in response to the UE receiving a handover command (MCG change) sent by the first node, a radio resource control reconfiguration RRCReconfiguration message sent by the network is received, and the radio resource control reconfiguration RRCReconfiguration includes a MCG configuration carrying a synchronization reconfiguration.

In an embodiment, if the radio resource control reconfiguration RRCReconfiguration message forwarded by the Source-Target Master Node (S-MN) from the Target-Master Node (T-MN) includes the indication information or the indication information is a specific value, the UE deletes the configuration information of condition-based mobility, and the configuration information is used for SCG selective activation; otherwise, the UE retains the LTM candidate cell configuration and retains the candidate SCG configuration. In an embodiment, if the radio resource control reconfiguration RRCReconfiguration message sent by the Source-Target Master Node (S-MN) includes the indication information or the indication information is a specific value, or the UE receives the indication information sent by the Source-Target Master Node (S-MN), the UE deletes the configuration information of condition-based mobility, and the configuration information is used for SCG selective activation; otherwise, the UE retains the LTM candidate cell configuration and retains the candidate SCG configuration.

In an embodiment, in response to that the radio resource control reconfiguration RRCReconfiguration message sent by the Source-Target Master Node (S-MN) and received by the UE or the radio resource control reconfiguration RRCReconfiguration message of the Target-Master Node (T-MN) forwarded by the Source-Target Master Node (S-MN) includes the indication information or the indication information is a specific value, and the UE handover is successful (for example, the UE successfully accesses the target cell PCell), the UE deletes the configuration information of condition-based mobility, and the configuration information is used for SCG selective activation; otherwise, the UE retains the LTM candidate cell configuration and retains the candidate SCG configuration.

In an embodiment, the UE receiving the radio resource control reconfiguration RRCReconfiguration message which includes a synchronization reconfiguration and is sent by the first node also includes the following situation:

the UE triggers condition-based mobility for CHO/CPAC and a corresponding condRRCReconfig is applied.

As an example, if the UE triggers conditional mobility CHO/CPAC, the corresponding condRRCReconfig is applied. If the radio resource control reconfiguration RRCReconfiguration message corresponding to the condRRCReconfig (such as the radio resource control reconfiguration RRCReconfiguration message from the Target-Master Node (T-MN) or the Target-Secondary Node (T-SN)) includes the indication information, or the indication information is a specific value, the UE deletes the LTM configuration or the selective activation configuration.

In an embodiment, the indication information further includes a mobility command;
the mobility command is used to indicate at least one of the following:
indicating a cell or cell group change between different Central Units (CUs);
indicating a cell or cell group change in the same CU;
indicating a cell or cell group change between different access technologies;
indicating a cell or cell group change between different master nodes;
indicating a cell or cell group change in the same master node.

The cell or cell group change includes switching or updating or changing of a primary cell and a secondary cell of the UE. Different access technologies may include technologies for accessing E-UTRA and NR, and so on.

In an embodiment, the indication information may also indicate whether a corresponding mobility command, such as a handover command or SCG, is for the same CU (inter-CU) or the same node (inter-node) or different access technologies (inter-RAT). The UE determines whether to delete the LTM configuration or selective activation configuration stored in the UE according to the indication information.

As an example, if the mobility command received by the UE is inter-RAT mobility, the UE deletes the stored LTM configuration or selective activation configuration. The same node may include: the same master node and/or the same secondary node.

As an example, if the mobility command received by the UE is inter-CU or inter-node mobility, the UE deletes the stored LTM configuration or selective activation configuration.

As an example, the same node may include: the same master node and/or the same secondary node. As an example, the mobility command may include information about the cell or cell group change after the mobility action is triggered.

In an embodiment, the indication information is used to indicate the UE to perform a mobility action between different access technologies and to delete the configuration information related to the candidate cell or candidate cell group stored by the UE; or
the indication information is used to indicate the UE to perform a mobility action between different Central Units (CUs), and to delete the configuration information related to the candidate cell or candidate cell group stored by the UE;
the indication information is used to indicate the UE to perform a mobility action between different Master Nodes (MNs), and to delete the configuration information related to the candidate cell or the candidate cell group stored by the UE; or
the indication information is used to indicate the UE to perform a mobility action in the same Master Node (MN), and to retain the configuration information related to the candidate cell or candidate cell group stored by the UE.

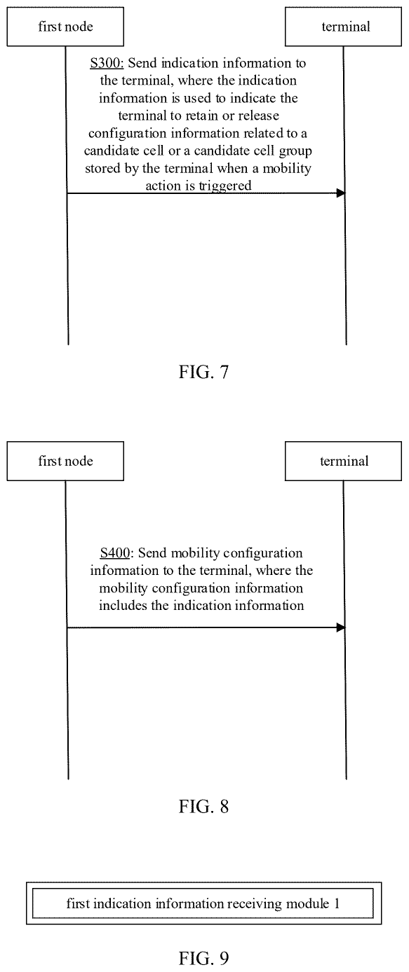

In an embodiment, referring to FIG. 7, a schematic diagram of another information processing method is shown. The method is applied to a first node, and the method includes:

In S300, indication information is sent to a UE. The indication information is used to indicate the UE to retain or delete configuration information related to a candidate cell or candidate cell group stored by the UE when a mobility action is triggered.

As an example, retaining or deleting the configuration information related to the candidate cell or the candidate cell group stored by the UE includes: retaining or deleting configuration information related to all candidate cell(s) or candidate cell group(s) corresponding to a MCG stored by the UE, and/or configuration information related to all candidate cell(s) or candidate cell group(s) corresponding to a SCG.

As an example, retaining or deleting the configuration information related to the candidate cell or candidate cell group stored by the UE includes: retaining or deleting the configuration information related to a part of candidate cell(s) or candidate cell group(s) corresponding to a MCG stored by the UE, and/or configuration information related to a part of candidate cell(s) or candidate cell group(s) corresponding to a SCG. The configuration information related to a part of candidate cell(s) or candidate cell group(s) may be specified by the network, specified by a specification, or determined by UE implementation.

The first node may include a base station. The base station may be an evolved node base station (eNB), or a node in a 5G system, for example a device such as a next generation node base station (gNB), or a Transmission and Reception Point (TRP), etc., or a network device in a subsequent evolved communication system.

In an embodiment, the deletion in various embodiments may be removal or release.

In an example, the first node may include a master node and/or a secondary node. The master node may be a base station corresponding to a primary cell or a master cell group, and the secondary node may be a base station corresponding to a primary secondary cell or a secondary cell group.

In an example, the UE is connected to the first node and may receive the indication information sent by the first node. The indication information may at least be generated by the first node and sent to the UE.

In an example, after receiving the indication information, the UE may determine, based on the indication information, whether to retain or delete the configuration information related to the candidate cell or candidate cell group stored by the UE when the mobility action is triggered.

In an example, the condition(s) that trigger the UE to perform the mobility action includes (include) but not limited to one or more of the following:
a trigger condition included in or corresponding to mobility configuration information being fulfilled;
an instruction for triggering the mobility action sent by a network device being received, where the instruction is used to indicate the UE to perform the mobility action.

As an example, the trigger condition included in the mobility configuration information may include: if the trigger condition for a cell selective configuration included in the mobility configuration being fulfilled, and/or the trigger condition corresponding to the mobility configuration information being fulfilled may include: a handover condition for a cell conditional handover is fulfilled, and the UE can automatically determine whether the mobility action is triggered.

In some other embodiments, the network device may indicate the UE to perform a mobility action through Layer 1 (L1) signaling, Layer 2 (L2) and/or Layer 3 (L3) signaling. Layer 1 may be a physical layer, and the signaling of the physical layer may at least include Downlink Control Information (DCI). The signaling of Layer 2 may at least include: Media Access Control (MAC) Control Element (CE), etc. Layer 3 signaling may include: Radio Resource Control (RRC) signaling.

In an embodiment, the mobility action(s) performed by the UE includes (include) various actions related to various serving cell updates (or changes) of the UE. As an example, the mobility action(s) performed by the UE includes (include) one or more of the following: an action related to UE's primary cell change, an action related to the UE's master cell group change, an action related to the UE's secondary cell change; an action related to the UE's secondary cell group change.

As described above, the UE may, according to the indication information, retain or delete the stored configuration information related to the candidate cell or candidate cell group after the mobility action is triggered. It can be understood that after the UE triggers the mobility action, it indicates that the candidate cell or candidate cell group of the UE may change, and the configuration information related to the candidate cell or candidate cell group currently stored by the UE may no longer be applicable or may be applicable. Thus, the UE receives the indication information sent by the first node, and the indication information may be used by the UE to determine whether it is needed to delete the configuration information related to the candidate cell or candidate cell group currently stored by the UE itself. Thus, the method can avoid a situation in related art that the UE does not receive the indication information and cannot know whether it is needed to delete the configuration information related to the candidate cell or candidate cell group, and thus the UE mistakenly retain or delete the configuration information related to the candidate cell or candidate cell group. For example, when the UE mistakenly retains the configuration information related to the candidate cell or candidate cell group that is no longer applicable, after the UE performs the mobility action, the use of the wrong configuration information related to the candidate cell or candidate cell group causes a phenomenon of a failure in accessing a serving cell or a serving cell group or poor communication quality after access. The present application clarifies the configuration information related to the candidate cell(s) or candidate cell group(s) which is no longer applicable through the indication information, which is conducive to improving the access success rate and/or communication quality. For another example, when the UE mistakenly removes the applicable configuration information related to the candidate cell(s) or candidate cell group(s), it is needed to reconfigure applicable configuration information related to the candidate cell(s) or candidate cell group(s).

In an embodiment, the indication information is used to indicate the UE to retain or delete the configuration information under a preset condition. The preset condition includes during a procedure of performing the mobility action, or after execution of the mobility action, or before execution of the mobility action.

The indication information is used to indicate that the configuration information may be retained or deleted according to the indication information during the procedure of the UE performing the mobility action; or, the indication information is used to indicate that the configuration information is retained or deleted after the UE performs the mobility action; or, the indication information is used to indicate that before the UE performs the mobility action, the UE determines to perform the mobility action, and the UE retains or deletes the configuration information according to the indication information.

In an embodiment, the indication information may be character-type indication information, such as 0 and 1, etc. The indication information may also be explicit indication information or implicit indication information.

In an embodiment, referring to FIG. 8, a schematic diagram of another information processing method provided by an embodiment is shown. The method may be applied to a first node. The method includes:

In S400, mobility configuration information is sent to a UE. The mobility configuration information includes the indication information.

As an example, the mobility configuration information is L3 configuration information.

In an embodiment, the configuration information related to the candidate cell or the candidate cell group includes: L1/L2 Triggered Mobility (LTM) configuration information of the candidate
cell or candidate cell group; and/or
selective activation configuration information of the candidate cell or the candidate cell group.

L1 and/or L2-triggered mobility (L1/L2-Triggered Mobility, LTM) configuration information may be configuration information activated by L1 and/or L2 instruction. Cell selective activation configuration information may be configuration information activated by the UE when an activation condition is fulfilled.

The selective activation configuration information may include at least one of the following:
a configuration information identity, including a configuration ID;
condition information, including an activation condition and a trigger conditions;
the configuration information of a candidate cell or candidate cell group, including configuration information of a cell group or cell to be activated, where the cell group or cell to be activated becomes a target cell or target cell group after being activated.

Different mobility configuration information may have different configuration information identities. For example, any two of L1 mobility configuration information, L2 mobility configuration information and L3 mobility configuration information may have different configuration information identities.

The mobility configuration information corresponding to different candidate cells or cell groups may have different configuration information identities. For example, mobility configuration information corresponding to a first candidate cell or cell group has a configuration ID1, and mobility configuration information corresponding to a second candidate cell or cell group has a configuration ID2.

The condition information indicates a trigger condition. If the trigger condition is fulfilled, it is considered that it is needed to trigger the mobility action of the UE. The trigger condition may include one or more of conditional trigger events A3, A4 or A5.

In an embodiment, after the UE triggers the mobility action, the UE accesses a target cell, and the target cell or target cell group is: a serving cell and/or serving cell group accessed after the UE's mobility action.

As an example, the mobility configuration information corresponding to the mobility action may be preconfigured by the network device for the UE, and each mobility configuration information corresponds to a cell or a cell group. The mobility configuration information may include a trigger condition, and the target cell or target cell group is one or more of cells or cell groups corresponding to a trigger condition fulfilled by the UE. Alternatively, the network indicates activation of a certain mobility configuration, and the target cell or target cell group is a cell or cell group corresponding to the mobility configuration to be activated as indicated by the network.

In an embodiment, the mobility action is used for a primary cell change or a master cell group change, and the indication information is used to indicate the UE to delete configuration information related to a candidate primary cell or a candidate master cell group stored by the UE, and delete configuration information related to a candidate secondary cell or a candidate secondary cell group.

After the mobility action is triggered, if the mobility action is used for the primary cell change or the master cell group change, the primary cell or the master cell group changes. In the case where the primary cell or the master cell group changes, the indication information indicates the UE to delete the configuration information related to the candidate primary cell or the candidate master cell group stored by the UE. After the candidate primary cell or the candidate master cell group changes, the candidate secondary cell or the candidate secondary cell group corresponding to the candidate primary cell or the candidate master cell group also changes, and thus the indication information also indicates the UE to delete the configuration information related to the candidate secondary cell or the candidate secondary cell group.

If the mobility action is an action of the UE's primary cell switch, or update or change, and the configuration information of the current primary cell is not deleted, the UE continues to store or use the configuration information of the current primary cell (that is, the source primary cell), the target primary cell after the mobility action may mistakenly refer to the configuration information of the source primary cell, thereby causing errors in applying the configuration information of the target primary cell.

As an example, if the target cell is the primary cell which the UE accesses after performing the mobility action, if the configuration information of the previous source primary cell is not deleted, the UE may mistakenly consider the configuration information of the source primary cell to be the configuration information of the target primary cell and use it.

After the UE performs the mobility action and before applying the target cell or the configuration information of the target cell, it is needed to delete a part or all of the configuration information of the current cell and/or the current cell group, so as to reduce the errors in applying the configuration information of the target cell and/or the target cell group.

In an embodiment, the mobility action is used for the primary cell change or the master cell group change, the master node which the UE accesses changes, and the master node which the UE accesses is changed from the Source-Master Node (S-MN) of the source primary cell or the source master cell group to the Target-Master Node (T-MN) of the target primary cell or the target master cell group. The target primary cell or the target master cell group is different from the source primary cell or the source master cell group, and the indication information is used to indicate the UE to delete the configuration information related to the source primary cell or the source master cell group stored by the UE, and delete the configuration information related to the source secondary cell or the source secondary cell group.

In an embodiment, the mobility action is used for a primary secondary cell change or a secondary cell group change, and the indication information is used to indicate the UE to delete the configuration information related to the candidate secondary cell or the candidate secondary cell group stored by the UE.

After the mobility action is triggered, if the primary secondary cell or the secondary cell group changes, the secondary node which the UE accesses changes. In this case, the indication information indicates the UE to delete the configuration information related to the candidate secondary cell or candidate secondary cell group stored by the UE. Triggering the mobility action for the primary secondary cell or the secondary cell group indicates that the primary secondary cell or the secondary cell group of the UE will be switched to the target primary secondary cell or the secondary cell group. In order to reduce the interference of the configuration information of the current primary secondary cell or the current secondary cell group on application of the configuration information of the target cell or the target cell group, a part and/or all of the configuration information of the current primary secondary cell or the current secondary cell group is deleted.

If the mobility action is an action of the UE's primary cell switch or update or change and the configuration information of the current secondary cell is not deleted, the UE continues to store or use the configuration information of the current secondary cell (that is, the source secondary cell), the target secondary cell after the mobility action may mistakenly refer to the configuration information of the source secondary cell, thereby causing errors in applying the configuration information of the target secondary cell.

As an example, if the target cell is a secondary cell which the UE accesses after performing a mobility action, if the configuration information of the previous source secondary cell is not deleted, the UE may mistakenly consider the configuration information of the source secondary cell to be the configuration information of the target secondary cell.

After the UE performs the mobility action and before applying the target cell or the configuration information of the target cell, it is needed to delete a part or all of the configuration information of the current cell and/or the current cell group, so as to reduce errors in applying the configuration information of the target cell and/or the target cell group.

In this case, the primary cell or master cell group may or may not change, the Master Node (MN) of the primary cell or master cell group may or may not change, and the Source-Master Node (S-MN) including the source-primary cell or source-master cell group may or may not change.

In an embodiment, the candidate primary cell(s) includes (include) a source secondary cell and a target secondary cell, and the candidate master cell group(s) includes (include) a source secondary cell group and a target secondary cell group. Since the secondary cell or secondary cell group changes, the secondary node connected to the UE also changes, and the mobility action is used for the primary secondary cell change or the secondary cell group change. The Target-Secondary Node (T-SN) of the target secondary cell or target secondary cell group is different from the Source-Secondary Node (S-SN) of the source secondary cell or source secondary cell group, and the secondary node which the UE accesses is changed from the Source-Secondary Node (S-SN) of the source secondary cell or source secondary cell group to the Target-Secondary Node (T-SN) of the target secondary cell or target secondary cell group. Therefore, the indication information indicates the UE to delete the configuration information related to the primary secondary cell or secondary cell group, and thus the indication information indicates the UE to delete the configuration information related to the source secondary cell or source secondary cell group.

In an embodiment, the mobility action is used for the primary cell change or the master cell group change, and the indication information is used to indicate the UE to retain the configuration information related to the candidate primary cell or the candidate master cell group stored by the UE, and to retain the configuration information related to the candidate secondary cell or the candidate secondary cell group stored by the UE.

After the mobility action is triggered, if the primary cell or the master cell group does not change, in this case, the indication information indicates the UE to retain the configuration information related to the candidate primary cell or the candidate master cell group. If the mobility action is an action of not switching or not updating or not changing the primary cell of the UE, and the configuration information of the current secondary cell is retained, the UE continues to store or use the configuration information of the current primary cell (that is, the source primary cell), the target primary cell after the mobility action will refer to the configuration information of the source primary cell, and there is no need to re-obtain new configuration information.

As an example, if the target cell is a primary cell which the UE accesses after performing the mobility action, if the configuration information of the previous source primary cell is deleted, the UE needs to re-obtain the configuration information of the primary cell.

After the UE performs the mobility action and before applying the target cell or the configuration information of the target cell, it is needed to retain a part or all of the configuration information of the current cell and/or the current cell group, thereby reducing the procedure of re-obtaining the configuration information of the target cell and/or the target cell group.

In an embodiment, after the mobility action is triggered, if the primary cell or the master cell group does not change, the target primary cell or the target master cell group is the same as the source primary cell or the source master cell group. In the case where the primary cell or the master cell group does not change, the master node which the UE accesses does not change, and the master node which the UE accesses is still the Source-Master Node (S-MN) of the source primary cell or the source master cell group, and the Target-Master Node (T-MN) of the target primary cell or the target master cell group is the same as the Source-Master Node (S-MN) of the source primary cell or the source master cell group. In this case, the indication information indicates the UE to retain the configuration information related to the candidate primary cell or the candidate master cell group.

In another embodiment, the Target-Master Node (T-MN) of the target primary cell or the target master cell group is the same as the Source-Master Node (S-MN) of the source primary cell or the source master cell group, and the Target-Secondary Node (T-SN) of the target secondary cell or the target secondary cell group is the same as the Source-Secondary Node (S-SN) of the candidate secondary cell or the candidate secondary cell group, and the indication information is also used to indicate the UE to retain the configuration information related to the candidate secondary cell or the candidate secondary cell group.

In an embodiment, when the Target-Master Node (T-MN) of the target primary cell or the target master cell group is the same as the Source-Master Node (S-MN) of the source primary cell or the source master cell group, the primary cell does not change, and the source primary cell which the UE accesses does not change. If the source secondary cell or the source secondary cell group corresponding to the source primary cell or the source master cell group changes, and the Target-Secondary Node (T-SN) of the target secondary cell or the target secondary cell group is different from the Source-Secondary Node (S-MN) of the source secondary cell or the source secondary cell group, the indication information indicates the UE to delete the configuration information related to the source secondary cell or the source secondary cell group.

In an embodiment, the mobility action is used for the primary secondary cell or the secondary cell group, and the indication information is used to indicate the UE to retain the configuration information related to the candidate secondary cell or the candidate secondary cell group stored by the UE.

After the mobility action is triggered, if the primary secondary cell or the secondary cell group does not change, the indication information is used to indicate the UE to retain the configuration information related to the candidate secondary cell or the candidate secondary cell group stored by the UE.

If the mobility action is an action of not switching or not updating or not changing the UE's secondary cell, and the configuration information of the current secondary cell is retained, the UE continues to store or use the configuration information of the current secondary cell (that is, the source secondary cell), the target secondary cell after the mobility action will refer to the configuration information of the source secondary cell, and there is no need to re-obtain new configuration information.

As an example, if the target cell is a primary cell which the UE accesses after performing the mobility action, if the configuration information of the previous source secondary cell is deleted, the UE needs to re-obtain the configuration information of the secondary cell.

After the UE performs the mobility action and before applying the target cell or the configuration information of the target cell, it is needed to retain a part or all of the configuration information of the current cell and/or the current cell group, thereby reducing the procedure of re-obtaining the configuration information of the target secondary cell and/or the target secondary cell group.

In an embodiment, the candidate primary cell(s) includes (include) a source secondary cell and a target secondary cell, and the candidate master cell group(s) includes (include) a source secondary cell group and a target secondary cell group. The Target-Secondary Node (T-SN) of the target secondary cell or the target secondary cell group is the same as the Source-Secondary Node (S-SN) of the source secondary cell or the source secondary cell group. If the Source-Secondary Node (S-SN) of the source secondary cell or the source secondary cell group does not change, it means that the secondary cell or the secondary cell group does not change. The secondary node which the UE accesses does not change. In this case, the indication information indicates the UE to retain the configuration information related to the secondary primary cell or the secondary master cell group stored by the UE.

In an embodiment, the method further comprises:
generating the indication information; or
receiving the indication information from a second node.

The indication information may be generated by the first node, or may be received indication information sent by the second node to the first node, that is, the indication information is received from the second node.

In an embodiment, the mobility action is used for the primary cell change or the master cell group change, and the indication information is generated by the Target-Master Node (T-MN).

In this case, the indication information is generated by the Target-Master Node (T-MN) of the target cell or target cell group, and the first node receives the indication information sent by the Target-Master Node (T-MN) to the first node. The Target-Master Node (T-MN) is different from the first node, and the first node may be a Source-Master Node (S-MN) or a Source-Secondary Node (S-SN).

For example, the indication information is generated by the Target-Master Node (T-MN) and included in a handover request response message sent by the Target-Master Node (T-MN) to the Source-Master Node (S-MN).

For another example, the indication information is included in a handover command sent by the Target-Master Node (T-MN) to the Source-Master Node (S-MN).

As an example, the indication information is included in a handover command message, and the handover command message may be handoverCommandMessage.

As an example, the indication information is included in a command message field. The command message includes the command message field. The command message field may be handoverCommand.

As an example, the indication information is included in a target cell radio resource reconfiguration RRCReconfiguration message, and the radio resource reconfiguration RRCReconfiguration message includes a handover command message handoverCommandMessage.

After the Source-Master Node (S-MN) receives the handover command sent by the Target-Master Node (T-MN), the Source-Master Node (S-MN) sends the transparent Container: RRCReconfiguration generated by the Target-Master Node (T-MN) in the handover command to the UE, triggering Uu handover, such as a Master Cell Group (MCG) change or a Primary Cell (PCell) change.

In an embodiment, the mobility action is used for the primary cell change or the master cell group change, and the indication information is generated by the Source-Master Node (S-MN).

In this case, the indication information is generated by a Source-Master Node (S-MN) of a source primary cell or a source master cell group, and the first node sends the indication information to the UE.

For example, when the Source-Master Node (S-MN) sends a Uu interface handover command message to the UE to trigger the Uu handover, the Source-Master Node (S-MN) carries this indication information. The handover command may be represented by a radio resource reconfiguration RRCReconfiguration message.

For example, a message including a handover command from the Target-Master Node (T-MN) and the indication information generated by the Source Master Node (S-MN) is sent to the UE, for example, an RRC message is sent to the UE.

As an example, a first radio resource reconfiguration RRCReconfiguration message includes a second radio resource reconfiguration RRCReconfiguration message and the indication information, and the Source-Master Node (S-MN) sends the first radio resource reconfiguration RRCReconfiguration to the UE, where the second radio resource reconfiguration RRCReconfiguration message is forwarded by the Target-Master Node (T-MN) to the source-master node S-MN.

As an example, the Source-Master Node (S-MN) sends this indication information to the UE before sending a Uu port switching command to the UE to trigger the Uu handover. The handover command is a type of radio resource reconfiguration RRCReconfiguration message.

In an embodiment, the mobility action is used for the primary secondary cell change or the secondary cell group change, and the indication information is generated by the Target-Secondary Node (T-SN).

In this case, the indication information is generated by the Target-Secondary Node (T-SN), and the first node receives the indication information sent by the Target-Secondary Node (T-SN) to the first node. The Target-Secondary Node (T-SN) is different from the first node, and the first node may be a Source-Master Node (S-MN) or a Source-Secondary Node (S-SN).

As an example, the indication information is applicable to a Secondary Cell Group (SCG) change initiated by a Master Node (MN) and a Secondary Cell Group (SCG) change initiated by a Secondary Node (SN).

The initiation is included in an addition request response message sent by the T-SN to the MN. For example, the indication information is included in a CG-Config sent by the T-SN to the S-MN.

As an example, it is included in the target Secondary Cell Group (SCG) configuration (scg-CellGroupConfig)

As an example, it is included in the target cell configuration RRCReconfiguration corresponding to scg-CellGroupConfig.

As an example, after the Master Node (MN) receives the target Secondary Cell Group (SCG) configuration sent by the Target-Secondary Node (T-SN), the Master Node (MN) includes, in the radio resource reconfiguration RRCReconfiguration message generated by MN, the node radio resource reconfiguration RRCReconfiguration message (SN RRCReconfiguration) including the indication information generated by the Target-Secondary Node (T-SN) in the target Secondary Cell Group (SCG) configuration, and sends it to the UE, triggering the UE to apply the target Secondary Cell Group (SCG) configuration, such as the Secondary Cell Group (SCG) change or the Primary Secondary Cell (PSCell) change.

As an example, the radio resource reconfiguration RRCReconfiguration message from the Secondary Node (SN) may be configured through a mrdc-SecondaryCellGroup domain, and thus the mrdc-SecondaryCellGroup includes the radio resource reconfiguration RRCReconfiguration message generated by the Secondary Node (SN). The RRC message may include the indication information. For example, the RRC message may only include the domain(s) secondaryCellGroup, otherConfig, conditionalReconfiguration, measConfig, bap-Config, IAB-IP-AddressConfigurationList, and a domain corresponding to the indication information.

In an embodiment, the mobility action is used for the primary secondary cell change or the secondary cell group change, and the indication information is generated by the Source-Secondary Node (S-SN).

As an example, the indication information is applicable to a Secondary Cell Group (SCG) change initiated by a Secondary Node (SN).

The Source-Secondary Node (S-SN) initiates the Secondary Cell Group (SCG) change process by sending a Secondary Node (SN) change request message to the Target-Master Node (T-MN), where the indication information may be carried in the Source-Secondary Node (S-SN) change request message. Then, the Master Node (MN) sends, to the UE, the indication information sent by the Source-Secondary Node (S-SN) to the Master Node (MN), and the UE receives the indication information.

As an example, the Source-Secondary Node (S-SN) sends the indication information to the UE, and the UE determines whether to retain the configuration of LTM or selective activation of the Secondary Cell Group (SCG) according to the indication information.

In an embodiment, the mobility action is used for the primary secondary cell change or the secondary cell group change, and the indication information is generated by a Master Node (MN).

As an example, it is applicable to a Secondary Cell Group (SCG) change initiated by a Master Node (MN) and a Secondary Cell Group (SCG) change initiated by a Secondary Node (SN).

When the Master Node (MN) triggers the UE to initiate a Secondary Cell Group (SCG) change, it carries the indication information. For example, when the MN sends a MN RRCReconfiguration message including SN RRCReconfiguration to the UE, the MN carries the indication information.

As an example, the first node sends, to the UE, a message including the target Secondary Cell Group (SCG) configuration (such as SN RRCReconfiguration) from the Target-Secondary Node (T-SN) and the indication information generated by the Master Node (MN) (e.g., the RRC message of the Master Node (MN) is sent to the UE), and the UE receives the indication.

As an example, the Master Node (MN) radio resource control reconfiguration RRCReconfiguration message includes the Secondary Node (SN) radio resource control reconfiguration RRCReconfiguration message and the indication information, and the Master Node (MN) sends the Master Node (MN) radio resource control reconfiguration RRCReconfiguration to the UE, and the UE receives the indication information. The Secondary Node (SN) radio resource control reconfiguration RRCReconfiguration message is forwarded by the Source-Secondary Node (S-SN) to the Master Node (MN), and corresponds to the configuration information of the target Secondary Cell Group (SCG).

For example, a mrdc-SecondaryCellGroupConfig domain in the radio resource control reconfiguration RRCReconfiguration message generated by the Master Node (MN) includes the indication information and a mrdc-SecondaryCellGroup domain for configuring the SN RRCReconfiguration.

As an example, before triggering the UE to initiate a Secondary Cell Group (SCG) change, the Master Node (MN) sends the indication information to the UE, for example, sending a MN RRCReconfiguration message including SN RRCReconfiguration to the UE.

In an embodiment, the mobility action is used for the primary cell change or the master cell group change, and the first node is a Source-Master Node (S-MN) or a Source-Secondary Node (S-SN) of the primary secondary cell; or

the mobility action is used for the primary secondary cell change or the secondary cell group change, and the first node is a Master Node (MN).

In an embodiment, only the Source-Master Node (S-MN) or the current Master Node (MN) can directly send information to the UE, and the Target-Master Node (T-MN) or the Secondary Node (SN) cannot send the indication information to the UE at the current moment.

In an embodiment, the indication information is included in a radio resource reconfiguration RRCReconfiguration message.

In an embodiment, the RRCReconfiguration message includes: a handover command message, used to indicate a cell handover or a cell group handover for the UE. In an embodiment, the method further comprises:

generating a radio resource control reconfiguration RRCReconfiguration message including the indication information, wherein the mobility action is used for the primary cell change or the master cell group change and the first node is the Source-Master Node (S-MN).

In this embodiment, the first node is a Source-Master Node (S-MN), and the indication information is generated by the Source-Master Node (S-MN). The Source-Master Node (S-MN) generates the radio resource control reconfiguration RRCReconfiguration message, and the radio resource control reconfiguration RRCReconfiguration message includes the indication information. The first node sends the radio resource control reconfiguration RRCReconfiguration message to the UE, and the UE can receive the indication information after receiving the radio resource control reconfiguration RRCReconfiguration message.

In an embodiment, the method further comprises:

generating a radio resource control reconfiguration RRCReconfiguration message including the indication information, wherein the mobility action is used for the primary secondary cell change or the secondary cell group change and the first node is the Master Node (MN).

In this embodiment, the first node is a Master Node (MN), and the indication information is generated by the Master Node (MN). The Master Node (MN) may generate tthe radio resource control reconfiguration RRCReconfiguration message including the indication information, and then send the generated radio resource control reconfiguration RRCReconfiguration message to the UE. The UE can receive the indication information by receiving the radio resource control reconfiguration RRCReconfiguration message sent by the Master Node (MN).

In an embodiment, the mobility action is used for the primary secondary cell change or the secondary cell group change and the first node is the Master Node (MN), the radio resource control reconfiguration RRCReconfiguration message of the Source-Secondary Node (S-SN) of the UE is received. The radio resource control reconfiguration RRCReconfiguration message includes the indication information.

The first node in this embodiment is a Master Node (MN), and the indication information is generated by the Source-Secondary Node (S-SN) of the UE. The Master Node (MN) may receive the radio resource control reconfiguration RRCReconfiguration message including the indication information generated by the Source-Secondary Node (S-SN) of the UE, and then send the generated radio resource control reconfiguration RRCReconfiguration message to the UE. The UE can receive the indication information by receiving the radio resource control reconfiguration RRCReconfiguration message sent by the Master Node (MN).

In an embodiment, the mobility action is used for the primary secondary cell change or the secondary cell group change and the first node is a Source-Secondary Node (S-SN), and the radio resource control reconfiguration RRCReconfiguration message is generated, wherein the RRCReconfiguration message includes the indication information.

The first node in this embodiment is a Source-Secondary Node (S-SN), and the indication information is generated by the Source-Secondary Node (S-SN). The Source-Secondary Node (S-SN) may generate the radio resource control reconfiguration RRCReconfiguration message including the indication information, and then send the generated radio resource control reconfiguration RRCReconfiguration message to the UE. The UE can receive the indication information by receiving the radio resource control reconfiguration RRCReconfiguration message sent by the Master Node (MN).

In an embodiment, the mobility action is used for the primary cell change or the master cell group change and the first node is the Source-Master Node (S-MN), and a radio resource control reconfiguration RRCReconfiguration message sent by the Target-Master Node (T-MN) is received, wherein the radio resource control reconfiguration RRCReconfiguration message includes the indication information.

The first node in this embodiment is the Source-Master Node (S-MN), and the indication information is generated by the Target-Master Node (T-MN). The Target-Master Node (T-MN) may generate the radio resource control reconfiguration RRCReconfiguration message including the indication information, and then send the generated radio resource control reconfiguration RRCReconfiguration message to the first node. The first node receives the radio resource control reconfiguration RRCReconfiguration message sent by the Target-Master Node (T-MN). The first node then sends the received radio resource control reconfiguration RRCReconfiguration message to the UE, and the UE can receive the indication information by receiving the radio resource control reconfiguration RRCReconfiguration message sent by the first node.

In an embodiment, the mobility action is used for the primary secondary cell change or the secondary cell group change and the first node is a Source-Secondary Node (S-SN), a radio resource control reconfiguration RRCReconfiguration message sent by a Target-Master Node (T-MN) is and received, wherein the radio resource control reconfiguration RRCReconfiguration message includes the indication information;

The first node in this embodiment is the Source-Secondary Node (S-SN), and the indication information is generated by the Target-Master Node (T-MN). The Target-Master Node (T-MN) may generate a radio resource control reconfiguration RRCReconfiguration message including the indication information, and then send the generated radio resource control reconfiguration RRCReconfiguration message to the Source-Secondary Node (S-SN). The Source-Secondary Node (S-SN) receives the radio resource control reconfiguration RRCReconfiguration message sent by the Target-Master Node (T-MN). The Source-Secondary Node (S-SN) then sends the received radio resource control reconfiguration RRCReconfiguration message to the UE, and the UE can receive the indication information by receiving the radio resource control reconfiguration RRCReconfiguration message sent by the Source-Secondary Node (S-SN).

In an embodiment, the mobility action is used for the primary secondary cell change or the secondary cell group change and the first node is the Source-Master Node (S-MN), a radio resource control reconfiguration RRCReconfiguration message sent by the Target-Secondary Node (T-SN) is received, wherein the radio resource control reconfiguration RRCReconfiguration message includes the indication information.

The first node in this embodiment is the Source-Master Node (S-MN), and the indication information is generated by the Target-Secondary Node (T-SN). The Target-Secondary Node (T-SN) may generate a radio resource control reconfiguration RRCReconfiguration message including the indication information, and then send the generated radio resource control reconfiguration RRCReconfiguration message to the Source-Master Node (S-MN). The Source-Master Node (S-MN) receives the radio resource control reconfiguration RRCReconfiguration message sent by the Target-Secondary Node (T-SN). The Source-Master Node (S-MN) then sends the received radio resource control reconfiguration RRCReconfiguration message to the UE, and the UE can receive the indication information by receiving the radio resource control reconfiguration RRCReconfiguration message sent by the Source-Master Node (S-MN).

In an embodiment, the mobility action is used for the primary secondary cell change or the secondary cell group change and the first node is the Source-Secondary Node (S-SN), a radio resource control reconfiguration RRCReconfiguration message sent by the Target-Secondary Node (T-SN) is received, wherein the radio resource control reconfiguration RRCReconfiguration message includes the indication information.

The first node in this embodiment is the Source-Secondary Node (S-SN), and the indication information is generated by the Target-Secondary Node (T-SN). The Target-Secondary Node (T-SN) may generate a radio resource control reconfiguration RRCReconfiguration message including the indication information, and then send the generated radio resource control reconfiguration RRCReconfiguration message to the Source-Secondary Node (S-SN). The source-secondary node S-SN receives the radio resource control reconfiguration RRCReconfiguration message sent by the Target-Secondary Node (T-SN). The Source-Secondary Node (S-SN) then sends the received radio resource control reconfiguration RRCReconfiguration message to the UE, and the UE can receive the indication information by receiving the radio resource control reconfiguration RRCReconfiguration message sent by the source-secondary node S-SN.

In an embodiment, the indication information corresponds to a preset field;

the indication information including the preset field is used to indicate retaining the configuration information related to the candidate cell or the candidate cell group; the indication information not including the preset field is used to indicate deleting the configuration information related to the candidate cell or the candidate cell group.

In an embodiment, the indication information corresponds to a preset field;

the indication information including the preset field is used to indicate deleting the configuration information related to the candidate cell or the candidate cell group; the indication information not including the preset field is used to indicate retaining configuration information related to the candidate cell or the candidate cell group.

In an embodiment, the indication information corresponds to a preset field;

a value of the preset filed included in the indication information being a first value is used to indicate deleting the configuration information related to the candidate cell or the candidate cell group; the value of the preset field included in the indication information being a second value is used to indicate retaining the configuration information related to the candidate cell or the candidate cell group.

In an embodiment, the radio resource control reconfiguration RRCReconfiguration message includes:

a handover command.

In an embodiment, the indication information is used to indicate the UE to delete or retain the LTM configuration or selective activation configuration stored by the UE after performing a mobility action (e.g., a Secondary Cell Group (SCG) change). The UE determines, based on the indication information, whether to retain or delete the stored LTM configuration, such as the candidate cell configuration corresponding to the LTM, for example, a configuration of the LTM of a Master Cell Group (MCG) or a Primary Cell (PCell) (e.g., a candidate MCG configuration), a configuration of the LTM of a Secondary Cell Group (SCG) or a Primary Secondary Cell (PSCell) (e.g., a candidate SCG configuration). And/or, the UE determines whether to retain or release the conditional mobility configuration of selective activation based on the indication information.

In an embodiment, the indication information corresponds to a preset field;

whether the message, in which the indication information is included, includes the preset field or the content of the preset field is used to indicate releasing or retaining the configuration information related to the candidate cell or the candidate cell group.

In an embodiment, the message, in which the indication information is included, including the preset field is used to indicate releasing the configuration information related to the candidate cell or the candidate cell group, and the message, in which the indication information is included, not including the preset field is used to indicate the retaining the configuration information related to the candidate cell or the candidate cell group.

Alternatively, in an embodiment, the message, in which the indication information is included, including the preset field is used to indicate retaining the configuration information related to the candidate cell or the candidate cell group, and the message, in which the indication information is included, not including the preset field is used to indicate releasing the configuration information related to the candidate cell or the candidate cell group.

In an embodiment, the indication information is included in a radio resource control reconfiguration RRCReconfiguration message. Whether the radio resource control reconfiguration RRCReconfiguration message includes the preset field is used to indicate whether to delete or retain configuration information related to the candidate cell or the candidate cell group.

For example, if the first node sends the indication information or the mobility trigger command message of a response includes the indication information, the UE retains the stored LTM and/or selective activation configuration. If the indication information is not included, the UE deletes the stored LTM and/or selective activation configuration. For another example, if the first node sends the indication information or the mobility trigger command message of the response includes the indication information, the UE deletes the stored LTM and/or selective activation configuration. If the indication information is not included, the UE retains the stored LTM and/or selective activation configuration.

In an embodiment, the radio resource control reconfiguration RRCReconfiguration message including the preset field is used to indicate deleting the configuration information related to the candidate cell or the candidate cell group. The radio resource control reconfiguration RRCReconfiguration message not including the preset field is used to indicate retaining the configuration information related to the candidate cell or the candidate cell group.

In an embodiment, the radio resource control reconfiguration RRCReconfiguration message including the preset field is used to indicate retaining the configuration information related to the candidate cell or candidate cell group. The radio resource control reconfiguration RRCReconfiguration message not including the preset field is used to indicate deleting the configuration information related to the candidate cell or candidate cell group.

In an embodiment, the value of the preset field included in the radio resource control reconfiguration RRCReconfiguration message is used to indicate deleting or retaining the configuration information related to the candidate cell or the candidate cell group.

The preset field may be determined according to actual usage requirements and is not limited here.

In an embodiment, the value of the preset field included in the message, in which the indication information is included, being a first value is used to indicate releasing the configuration information related to the candidate cell or the candidate cell group; the value of the preset field included in the message, in which the indication information is included, being a second value is used to indicate retaining the configuration information related to the candidate cell or the candidate cell group; or

the value of the preset field included the message, in which the indication information is included, being a second value is used to indicate releasing the configuration information related to the candidate cell or the candidate cell group; the value of the preset field included in the message, in which the indication information is included, being a first value is used to indicate retaining the configuration information related to the candidate cell or the candidate cell group.

As an example, the indication information is included in a radio resource control reconfiguration RRCReconfiguration message.

In an embodiment, the value of the preset field included in the radio resource control reconfiguration RRCReconfiguration message being a first value is used to indicate deleting the configuration information related to the candidate cell or the candidate cell group. The value of the preset field included in the radio resource control reconfiguration RRCReconfiguration message being a second value is used to indicate retaining the configuration information related to the candidate cell or the candidate cell group.

In an embodiment, the value of the preset field included in the radio resource control reconfiguration RRCReconfiguration message being the second value is used to indicate deleting the configuration information related to the candidate cell or the candidate cell group. The value of the preset field included in the radio resource control reconfiguration RRCReconfiguration message being the first value is used to indicate retaining the configuration information related to the candidate cell or the candidate cell group.

As an example, the first node sends the indication information or the mobility trigger command message of a response includes the indication information, and the indication information is a first specific value, the UE deletes the stored LTM and/or selective activation configuration; if the indication information is a second specific value, the UE retains the stored LTM and/or selective activation configuration.

In an embodiment, in response to the UE receiving a radio resource control reconfiguration RRCReconfiguration message sent by the first node, the radio resource control reconfiguration RRCReconfiguration includes a MCG configuration carrying a synchronization reconfiguration. The radio resource control reconfiguration RRCReconfiguration message includes a handover command.

If the UE receives the radio resource control reconfiguration RRCReconfiguration message forwarded by the Source-Master Node (S-MN) from the Target-Master Node (T-MN) and the RRCReconfiguration message includes indication information or the indication information is a specific value, the UE deletes the LTM candidate cell configuration, deletes the candidate MCG configuration and/or the candidate SCG configuration; otherwise, the UE retains the LTM candidate cell configuration, retains the candidate MCG configuration and/or the candidate SCG configuration.

If the UE receives the radio resource control reconfiguration RRCReconfiguration message sent by the Source-Master Node (S-MN) and the RRCReconfiguration message includes the indication information or a value of the indication information is a specific value or the UE receives the indication information sent by the Source-Master Node (S-MN), the UE deletes the LTM candidate cell configuration, deletes the candidate MCG configuration and/or the candidate SCG configuration; otherwise, the UE retains the LTM candidate cell configuration, retains the candidate MCG configuration and/or the candidate SCG configuration.

In an embodiment, in response to that the radio resource control reconfiguration RRCReconfiguration message sent by the Source-Master Node (S-MN) and received by the UE or the radio resource control reconfiguration RRCReconfiguration message of the Target-Master Node (T-MN) forwarded by the Source-Master Node (S-MN) includes the indication information or the indication information is a specific value, and the UE handover is successful (for example, the UE successfully accesses the target cell PCell), the UE deletes the LTM candidate cell configuration, deletes the candidate MCG configuration and/or the candidate SCG configuration; otherwise, the UE retains the LTM candidate cell configuration, retains the candidate MCG configuration and/or the candidate SCG configuration.

In an embodiment, in response to the UE receiving a message sent by the network that triggers a Secondary Cell Group (SCG) change, for example, receiving a radio resource control reconfiguration RRCReconfiguration message sent by the first node, the radio resource control reconfiguration RRCReconfiguration includes a SCG configuration carrying a synchronization reconfiguration, including the indication information.

In an embodiment, if the UE receives a Secondary Node (SN) radio resource control reconfiguration RRCReconfiguration message from the Target-Secondary Node (T-SN) forwarded by the Master Node (MN), and the SN RRCReconfiguration message includes the indication information or the indication information is a specific value, the UE deletes the LTM candidate cell configuration and deletes the candidate SCG configuration; otherwise, the UE retains the LTM candidate cell configuration and retains the candidate SCG configuration.

In an embodiment, if the UE receives a Master Node (MN) radio resource control reconfiguration RRCReconfiguration message sent by the Master Node (MN), and the MN RRCReconfiguration message includes the Secondary Node (SN) radio resource control reconfiguration and also includes the indication information or the indication information is a specific value, or the UE receives the indication information sent by the Master Node (MN), the UE deletes the LTM candidate cell configuration and deletes the candidate SCG configuration; otherwise, the UE retains the LTM candidate cell configuration and retains the candidate SCG configuration.

In an embodiment, the UE receives the indication information sent by the Source-Secondary Node (S-SN), the UE deletes the candidate target configuration of the LTM and deletes the candidate SCG configuration; otherwise, the UE retains the LTM candidate cell configuration and retains the candidate SCG configuration.

In an embodiment, in response to that a radio resource control reconfiguration RRCReconfiguration message sent by the Master Node (MN) and received by the UE or the radio resource control reconfiguration RRCReconfiguration message of the Target-Master Node (T-MN) forwarded by the Master Node (MN) includes the indication information or the indication information is a specific value, or the UE receives the indication information sent by the Master Node (MN) or the Target-Secondary Node (T-SN) and the UE successfully performs the Secondary Cell Group (SCG) change (for example, the UE successfully accesses the target cell PSCell), the UE deletes the LTM candidate cell configuration and deletes the candidate SCG configuration; otherwise, the UE retains the LTM candidate cell configuration and retains the candidate SCG configuration.

In an embodiment, deleting the candidate target configuration of the LTM means deleting all candidate target configuration(s) stored in the UE, for example, all candidate MCG configuration(s) and/or all candidate SCG configuration(s), rather than configuration(s) of a specific candidate MCG or candidate SCG.

In an embodiment, the UE receives one or more pieces of configuration information of condition-based mobility sent by the first node, where the configuration information of condition-based mobility is used for SCG selective activation, and the UE receives and stores the configuration(s).

In an embodiment, in response to the UE receiving a handover command (MCG change) sent by the first node, a radio resource control reconfiguration RRCReconfiguration message sent by the network is received, and the radio resource control reconfiguration RRCReconfiguration includes a MCG configuration carrying a synchronization reconfiguration.

In an embodiment, if the radio resource control reconfiguration RRCReconfiguration message forwarded by the Source-Target Master Node (S-MN) from the Target-Master Node (T-MN) includes the indication information or the indication information is a specific value, the UE deletes the configuration information of condition-based mobility, and the configuration information is used for SCG selective activation; otherwise, the UE retains the LTM candidate cell configuration and retains the candidate SCG configuration.

In an embodiment, if the radio resource control reconfiguration RRCReconfiguration message sent by the Source-Target Master Node (S-MN) includes the indication information or the indication information is a specific value, or the UE receives the indication information sent by the Source-Target Master Node (S-MN), the UE deletes the configuration information of condition-based mobility, and the configuration information is used for SCG selective activation; otherwise, the UE retains the LTM candidate cell configuration and retains the candidate SCG configuration.

In an embodiment, in response to that the radio resource control reconfiguration RRCReconfiguration message sent by the Source-Target Master Node (S-MN) and received by the UE or the radio resource control reconfiguration RRCReconfiguration message of the Target-Master Node (T-MN) forwarded by the Source-Target Master Node (S-MN) includes the indication information or the indication information is a specific value, and the UE handover is successful (for example, the UE successfully accesses the target cell PCell), the UE deletes the configuration information of condition-based mobility, and the configuration information is used for SCG selective activation; otherwise, the UE retains the LTM candidate cell configuration and retains the candidate SCG configuration.

In an embodiment, the UE receiving the radio resource control reconfiguration RRCReconfiguration message which includes a synchronization reconfiguration and is sent by the first node also includes the following situation:

the UE triggers condition-based mobility for CHO/CPAC and a corresponding condRRCReconfig is applied.

As an example, if the UE triggers condition-based mobility for CHO/CPAC, the corresponding condRRCReconfig is applied. If the radio resource control reconfiguration RRCReconfiguration message corresponding to the condRRCReconfig (such as the radio resource control reconfiguration RRCReconfiguration message from the Target-Master Node (T-MN) or the Target-Secondary Node (T-SN)) includes the indication information, or the indication information is a specific value, the UE deletes the LTM configuration or the selective activation configuration.

In an embodiment, the indication information further includes a mobility command;
the mobility command is used to indicate at least one of the following:
indicating a cell or cell group change between different Central Units (CUs);
indicating a cell or cell group change in the same CU;
indicating a cell or cell group change between different access technologies;
indicating a cell or cell group change between different master nodes;
indicating a cell or cell group change in the same master node.

In an embodiment, the indication information may also indicate whether a corresponding mobility command, such as a handover command or SCG, is for the same CU (inter-CU) or the same node (inter-node) or different access technologies (inter-RAT). The UE determines whether to delete the LTM configuration or selective activation configuration stored in the UE according to the indication information.

As an example, if the mobility command received by the UE is inter-RAT mobility, the UE deletes the stored LTM configuration or selective activation configuration.

As an example, if the mobility command received by the UE is inter-CU or inter-node mobility, the UE deletes the stored LTM configuration or selective activation configuration.

As an example, inter-node includes inter-MN and inter-SN.

As an example, the mobility command may include information about a cell or

cell group change after a mobility action is triggered.

In an embodiment, the indication information is used to indicate the UE to perform the mobility action between different access technologies and to delete the configuration information related to the candidate cell or candidate cell group stored by the UE; or
the indication information is used to indicate the UE to perform the mobility action between different Central Units (CUs), and to delete configuration information related to the candidate cell or candidate cell group stored by the UE;
the indication information is used to indicate the UE to perform the mobility action between different Master Nodes (MNs), and to delete configuration information related to the candidate cell or candidate cell group stored by the UE; or
the indication information is used to indicate the UE to perform the mobility action in the same Master Node (MN), and to retain the configuration information related to the candidate cell or candidate cell group stored by the UE.

An embodiment of the present disclosure provides an information processing method. The method is applied to a second node, and includes:

sending indication information to a first node, wherein the indication information is used to indicate the terminal to retain or release configuration information related to a candidate cell or a candidate cell group after the indication information is sent by the first node to the terminal.

As an example, retaining or deleting the configuration information related to the candidate cell or the candidate cell group stored by the UE includes: retaining or deleting configuration information related to all candidate cell(s) or candidate cell group(s) corresponding to a MCG stored by the UE, and/or configuration information related to all candidate cell(s) or candidate cell group(s) corresponding to a SCG.

As an example, retaining or deleting the configuration information related to the candidate cell or candidate cell group stored by the UE includes: retaining or deleting the configuration information related to a part of candidate cell(s) or candidate cell group(s) corresponding to a MCG stored by the UE, and/or configuration information related to a part of candidate cell(s) or candidate cell group(s) corresponding to a SCG. The configuration information related to a part of candidate cell(s) or candidate cell group(s) may be specified by the network, specified by a specification, or determined by UE implementation.

In an example, the condition(s) that trigger the UE to perform the mobility action includes (include) but not limited to one or more of the following:
a trigger condition included in or corresponding to mobility configuration information being fulfilled;
an instruction sent by a network device being received, where the instruction is used to indicate the UE to perform the mobility action.

As an example, the trigger condition included in the mobility configuration information may include: if the trigger condition for a cell selective configuration included in the mobility configuration being fulfilled, and/or the trigger condition corresponding to the mobility configuration information being fulfilled may include: a handover condition for a cell conditional handover is fulfilled, and the UE can automatically determine whether the mobility action is triggered. In some other embodiments, the network device may indicate the UE to perform a mobility action through Layer 1 (L1) signaling, Layer 2 (L2) and/or Layer 3 (L3) signaling. Layer 1 may be a physical layer, and the signaling of the physical layer may at least include Downlink Control Information (DCI). The signaling of Layer 2 may at least include: Media Access Control (MAC) Control Element (CE), etc. Layer 3 signaling may include: Radio Resource Control (RRC) signaling.

In an embodiment, the mobility action(s) performed by the UE includes (include) various actions related to serving cell update (or change) of the UE. As an example, the mobility action(s) performed by the UE includes (include) one or more of the following: an action related to UE's primary cell change, an action related to the UE's master cell group change, an action related to the UE's secondary cell change; an action related to the UE's secondary cell group change.

As described above, the UE may, according to the indication information, retain or delete the stored configuration information related to the candidate cell or candidate cell group. It can be understood that after the UE triggers the mobility action, it indicates that the candidate cell or candidate cell group of the UE may change, and the configuration information related to the candidate cell or candidate cell group currently stored by the UE may no longer be applicable or may be applicable. Thus, the UE receives the indication information sent by the first node, and the indication information may be used by the UE to determine whether it is needed to delete the configuration information related to the candidate cell or candidate cell group currently stored by the UE itself. Thus, the method can avoid a situation in related art that the UE does not receive the indication information and cannot know whether it is needed to delete the configuration information related to the candidate cell or candidate cell group, and thus the UE mistakenly retain or delete the configuration information related to the candidate cell or candidate cell group. For example, when the UE mistakenly retains the configuration information related to the candidate cell or candidate cell group that is no longer applicable, after the UE performs the mobility action, the use of the wrong configuration information related to the candidate cell or candidate cell group causes a phenomenon of a failure in accessing a serving cell or a serving cell group or poor communication quality after access.

The present application clarifies the configuration information related to the candidate cell(s) or candidate cell group(s) which is no longer applicable through the indication information, which is conducive to improving the access success rate and/or communication quality. For another example, when the UE mistakenly removes the applicable configuration information related to the candidate cell(s) or candidate cell group(s), it is needed to reconfigure applicable configuration information related to the candidate cell(s) or candidate cell group(s).

In an embodiment, the indication information is used to indicate the UE to retain or delete the configuration information under a preset condition. The preset condition includes during a procedure of performing the mobility action, or after execution of the mobility action, or before execution of the mobility action.

The indication information is used to indicate that the configuration information may be retained or deleted according to the indication information during the procedure of the UE performing the mobility action; or
the indication information is used to indicate that the configuration information is retained or deleted after the UE performs the mobility action; or
the indication information is used to indicate that before the UE performs the mobility action, the UE determines to perform the mobility action, and the UE retains or deletes the configuration information according to the indication information.

In an embodiment, the indication information may be character-type indication information, such as 0 and 1, etc. The indication information may also be explicit indication information or implicit indication information.

In an embodiment, a schematic diagram of another information processing method is also provided. The method may be applied to a second node. The method includes:

sending mobility configuration information to the first node, wherein the mobility configuration information includes indication information.

As an example, the mobility configuration information is L3 configuration information.

In an embodiment, the configuration information related to the candidate cell or the candidate cell group includes:
L1/L2 Triggered Mobility (LTM) configuration information of the candidate cell or candidate cell group; and/or
selective activation configuration information of the candidate cell or the candidate cell group.

L1 and/or L2-triggered mobility (L1/L2-Triggered Mobility, LTM) configuration information may be configuration information activated by L1 and/or L2 instruction. Cell selective activation configuration information may be configuration information activated by the UE when an activation condition is fulfilled.

The selective activation configuration information may include at least one of the following:
a configuration information identity, including a configuration ID;
condition information, including an activation condition and a trigger conditions;
the configuration information of a candidate cell or candidate cell group, including configuration information of a cell group or cell to be activated, where the cell group or cell to be activated becomes a target cell or target cell group after being activated.

Different mobility configuration information may have different configuration information identities. For example, any two of L1 mobility configuration information, L2 mobility configuration information and L3 mobility configuration information may have different configuration information identities.

The mobility configuration information corresponding to different candidate cells or cell groups may have different configuration information identities. For example, mobility configuration information corresponding to a first candidate cell or cell group has a configuration ID1, and mobility configuration information corresponding to a second candidate cell or cell group has a configuration ID2.

The condition information indicates a trigger condition. If the trigger condition is fulfilled, it is considered that it is needed to trigger the mobility action of the UE. The trigger condition may include one or more of conditional trigger events A3, A4 or A5.

In an embodiment, after the terminal UE triggers the mobility action, the terminal accesses a target cell, and the target cell or target cell group is: a serving cell and/or serving cell group accessed after the mobility action of the terminal UE.

As an example, the mobility configuration information corresponding to the mobility action may be preconfigured by the network device for the terminal UE, and each mobility configuration information corresponds to a cell or a cell group. The mobility configuration information may include a trigger condition, and the target cell or target cell group is one or more of cells or cell groups corresponding to a trigger condition fulfilled by the terminal UE. Alternatively, the network indicates activation of a certain mobility configuration, and the target cell or target cell group is a cell or cell group corresponding to the mobility configuration to be activated as indicated by the network.

In an embodiment, the mobility action is used for the primary cell change or master cell group change, and the indication information is used to indicate the terminal to delete the configuration information related to the candidate primary cell or candidate master cell group stored by the terminal, and delete the configuration information related to the candidate secondary cell or candidate secondary cell group.

After the mobility action is triggered, if the mobility action is used for the primary cell change or the master cell group change, the primary cell or the master cell group changes. In the case where the primary cell or the master cell group changes, the indication information indicates the terminal to delete the configuration information related to the candidate primary cell or the candidate master cell group stored by the terminal. After the candidate primary cell or the candidate master cell group changes, the candidate secondary cell or the candidate secondary cell group corresponding to the candidate primary cell or the candidate master cell group also changes, and thus the indication information also indicates the terminal to delete the configuration information related to the candidate secondary cell or the candidate secondary cell group.

If the mobility action is an action of the UE's primary cell switch, or update or change, and the configuration information of the current primary cell is not deleted, the terminal UE continues to store or use the configuration information of the current primary cell (that is, the source primary cell), the target primary cell after the mobility action may mistakenly refer to the configuration information of the source primary cell, thereby causing errors in applying the configuration information of the target primary cell.

As an example, if the target cell is the primary cell which the UE accesses after performing the mobility action, if the configuration information of the previous source primary cell is not deleted, the UE may mistakenly consider the configuration information of the source primary cell to be the configuration information of the target primary cell and use it.

After the terminal UE performs the mobility action and before applying the target cell or the configuration information of the target cell, it is needed to delete a part or all of the configuration information of the current cell and/or the current cell group, so as to reduce the errors in applying the configuration information of the target cell and/or the target cell group.

In an embodiment, the mobility action is used for the primary cell change or the master cell group change, the master node which the terminal accesses changes, and the master node which the terminal accesses is changed from the Source-Master Node (S-MN) of the source primary cell or the source master cell group to the Target-Master Node (T-MN) of the target primary cell or the target master cell group. The target primary cell or the target master cell group is different from the source primary cell or the source master cell group, and the indication information is used to indicate the terminal to delete the configuration information related to the source primary cell or the source master cell group stored by the terminal, and delete the configuration information related to the source secondary cell or the source secondary cell group.

In an embodiment, the mobility action is used for the primary secondary cell change or the secondary cell group change, and the indication information is used to indicate the terminal to delete the configuration information related to the candidate secondary cell or the candidate secondary cell group stored by the terminal.

After the mobility action is triggered, if the primary secondary cell or the secondary cell group changes, the secondary node which the terminal accesses changes. In this case, the indication information indicates the terminal to delete the configuration information related to the candidate secondary cell or candidate secondary cell group stored by the terminal. Triggering the mobility action of the primary secondary cell or the secondary cell group indicates that the primary secondary cell or the secondary cell group of the terminal UE will be switched to the target primary secondary cell or secondary cell group. In order to reduce the interference of the configuration information of the current primary secondary cell or the current secondary cell group on the application of the configuration information of the target cell or the target cell group, a part and/or all of the configuration information of the current primary secondary cell or the current secondary cell group is deleted.

If the mobility action is an action of the UE's primary cell switch or update or change and the configuration information of the current secondary cell is not deleted, the terminal UE continues to store or use the configuration information of the current secondary cell (that is, the source secondary cell), the target secondary cell after the mobility action may mistakenly refer to the configuration information of the source secondary cell, resulting in errors in applying the configuration information of the target secondary cell.

As an example, if the target cell is a secondary cell which the UE accesses after performing the mobility action, if the configuration information of the previous source secondary cell is not deleted, the UE may mistakenly consider the configuration information of the source secondary cell to be the configuration information of the target secondary cell.

After the terminal UE performs the mobility action and before applying the target cell or the configuration information of the target cell, it is needed to delete a part or all of the configuration information of the current cell and/or the current cell group, so as to reduce the errors in applying the configuration information of the target cell and/or the target cell group.

In this case, the primary cell or master cell group may or may not change, the Master Node (MN) of the primary cell or master cell group may or may not change, and the Source-Master Node (S-MN) including the source-primary cell or source-master cell group may or may not change.

In an embodiment, the candidate primary cell(s) includes (include) a source secondary cell and a target secondary cell, and the candidate master cell group(s) includes (include) a source secondary cell group and a target secondary cell group. Since the secondary cell or secondary cell group changes, the secondary node to which the terminal is connected also changes, and the mobility action is used for the primary secondary cell change or secondary cell group change. The Target-Secondary Node (T-SN) of the target secondary cell or target secondary cell group is different from the Source-Secondary Node (S-SN) of the source secondary cell or source secondary cell group, and the secondary node which the terminal accesses is changed from the Source-Secondary Node (S-SN) of the source secondary cell or source secondary cell group to the Target-Secondary Node (T-SN) of the target secondary cell or target secondary cell group. Therefore, the indication information indicates the terminal to delete the configuration information related to the primary secondary cell or secondary cell group, and thus the indication information indicates the terminal to delete the configuration information related to the source secondary cell or source secondary cell group.

In an embodiment, the mobility action is used for the primary cell change or the master cell group change, and the indication information is used to indicate the terminal to retain the configuration information related to the candidate primary cell or the candidate master cell group stored by the terminal, and to retain the configuration information related to the candidate secondary cell or the candidate secondary cell group stored by the terminal.

After the mobility action is triggered, if the primary cell or the master cell group does not change, in this case, the indication information indicates the terminal to retain the configuration information related to the candidate primary cell or the candidate master cell group. If the mobility action is an action of not switching or not updating or not changing the primary cell of the UE, and the configuration information of the current secondary cell is retained, the terminal UE continues to store or use the configuration information of the current primary cell (that is, the source primary cell), the target primary cell after the mobility action will refer to the configuration information of the source primary cell, and there is no need to re-obtain new configuration information.

As an example, if the target cell is a primary cell which the UE accesses after performing the mobility action, if the configuration information of the previous source primary cell is deleted, the terminal UE needs to re-obtain the configuration information of the primary cell.

After the terminal UE performs the mobility action and before applying the target cell or the configuration information of the target cell, it is needed to retain a part or all of the configuration information of the current cell and/or the current cell group, thereby reducing the procedure of re-obtaining the configuration information of the target cell and/or the target cell group.

In an embodiment, after the mobility action is triggered, if the primary cell or the master cell group does not change, the target primary cell or the target master cell group is the same as the source primary cell or the source master cell group. In the case where the primary cell or the master cell group does not change, the master node which the terminal accesses does not change, and the master node which the terminal accesses is still the Source-Master Node (S-MN) of the source primary cell or the source master cell group, and the Target-Master Node (T-MN) of the target primary cell or the target master cell group is the same as the Source-Master Node (S-MN) of the source primary cell or the source master cell group. In this case, the indication information indicates the terminal to retain the configuration information related to the candidate primary cell or the candidate master cell group.

In another embodiment, the Target-Master Node (T-MN) of the target primary cell or the target master cell group is the same as the Source-Master Node (S-MN) of the source primary cell or the source master cell group, and the Target-Secondary Node (T-SN) of the target secondary cell or the target secondary cell group is the same as the Source-Secondary Node (S-SN) of the candidate secondary cell or the candidate secondary cell group, the indication information is also used to indicate the terminal UE to retain the configuration information related to the candidate secondary cell or the candidate secondary cell group.

In an embodiment, when the Target-Master Node (T-MN) of the target primary cell or the target master cell group is the same as the Source-Master Node (S-MN) of the source primary cell or the source master cell group, the primary cell does not change, and the source primary cell which the terminal accesses does not change. If the source secondary cell or the source secondary cell group corresponding to the source primary cell or the source master cell group changes, and the Target-Secondary Node (T-SN) of the target secondary cell or the target secondary cell group is different from the Source-Secondary Node (S-SN) of the source secondary cell or the source secondary cell group, the indication information indicates the terminal to delete the configuration information related to the source secondary cell or the source secondary cell group.

In an embodiment, the mobility action is used for the primary secondary cell or the secondary cell group, and the indication information is used to indicate the terminal to retain the configuration information related to the candidate secondary cell or the candidate secondary cell group stored by the terminal.

After the mobility action is triggered, if the primary secondary cell or the secondary cell group does not change, the indication information is used to indicate the terminal to retain the configuration information related to the candidate secondary cell or the candidate secondary cell group stored in the terminal.

If the mobility action is an action of not switching or not updating or not changing the secondary cell of the UE, and the configuration information of the current secondary cell is retained, the terminal UE continues to store or use the configuration information of the current secondary cell (that is, the source secondary cell), the target secondary cell after the mobility action will refer to the configuration information of the source secondary cell, and there is no need to re-obtain new configuration information.

As an example, if the target cell is the primary cell which the UE accesses after performing the mobility action, if the configuration information of the previous source secondary cell is deleted, the terminal UE needs to re-obtain the configuration information of the secondary cell.

After the terminal UE performs the mobility action and before applying the target cell or the configuration information of the target cell, it is needed to retain a part or all of the configuration information of the current cell and/or the current cell group, thereby reducing the procedure of re-obtaining the configuration information of the target secondary cell and/or the target secondary cell group.

In an embodiment, the candidate primary cell(s) includes (include) a source secondary cell and a target secondary cell, and the candidate master cell group(s) includes (include) a source secondary cell group and a target secondary cell group. The Target-Secondary Node (T-SN) of the target secondary cell or the target secondary cell group is the same as the Source-Secondary Node (S-SN) of the source secondary cell or the source secondary cell group. If the Source-Secondary Node (S-SN) of the source secondary cell or the source secondary cell group does not change, it means that the secondary cell or the secondary cell group does not change. The secondary node which the terminal accesses does not change. In this case, the indication information indicates the terminal to retain the configuration information related to the secondary primary cell or the secondary master cell group stored by the terminal.

In an embodiment, the mobility action is used for the primary cell change or the master cell group change, and the indication information is generated by the Target-Master Node (T-MN) and sent to the first node.

In this case, the second node is a Target-Master Node (T-MN), the indication information is generated by the Target-Master Node (T-MN) of the target cell or target cell group, and the Target-Master Node (T-MN) sends the indication information to the first node. The first node receives the indication information sent by the Target-Master Node (T-MN) to the first node. The Target-Master Node (T-MN) is different from the first node, and the first node may be a Source-Master Node (S-MN) or a Source-Secondary Node (S-SN).

For example, the indication information is generated by the Target-Master Node (T-MN) and included in a handover request response message sent by the Target-Master Node (T-MN) to the Source-Master Node (S-MN).

For another example, the indication information is included in a handover command sent by the Target-Master Node (T-MN) to the Source-Master Node (S-MN).

As an example, the indication information is included in a handover command message, and the handover command message may be handoverCommandMessage.

As an example, the indication information is included in a command message field. The command message includes the command message field. The command message field may be handoverCommand.

As an example, the indication information is included in a target cell radio resource reconfiguration RRCReconfiguration message, and the radio resource reconfiguration RRCReconfiguration message includes a handover command message handoverCommandMessage.

After the Source-Master Node (S-MN) receives the handover command sent by the Target-Master Node (T-MN), the Source-Master Node (S-MN) sends the transparent Container: RRCReconfiguration generated by the Target-Master Node (T-MN) in the handover command to the terminal UE, triggering Uu handover, such as the Master Cell Group (MCG) change or the Primary Cell (PCell) change.

In an embodiment, the mobility action is used for the primary secondary cell change or the secondary cell group change, and the indication information is generated by the Target-Secondary Node (T-SN) and sent to the first node.

In this case, the second node is a Target-Secondary Node (T-SN), and the indication information is generated by the Target-Secondary Node (T-SN). The second node sends the indication information to the first node, and the first node receives the indication information sent by the Target-Secondary Node (T-SN) to the first node. The Target-Secondary Node (T-SN) is different from the first node, and the first node may be a Source-Master Node (S-MN) or a Source-Secondary Node (S-SN).

As an example, the indication information is applicable to a Secondary Cell Group (SCG) change initiated by a Master Node (MN) and a Secondary Cell Group (SCG) change initiated by a Secondary Node (SN).

The initiation is included in an addition request response message sent by the T-SN to the MN. For example, the indication information is included in a CG-Config sent by the T-SN to the S-MN.

As an example, it is included in a target Secondary Cell Group (SCG) configuration (scg-CellGroupConfig).

As an example, it is included in a target cell configuration RRCReconfiguration corresponding to scg-CellGroupConfig.

As an example, after the Master Node (MN) receives the target Secondary Cell Group (SCG) configuration sent by the Target-Secondary Node (T-SN), the Master Node (MN) includes, in the radio resource reconfiguration RRCReconfiguration message generated by MN, the node radio resource reconfiguration RRCReconfiguration message (SN RRCReconfiguration) including the indication information generated by the Target-Secondary Node (T-SN) in the target Secondary Cell Group (SCG) configuration, and sends it to the terminal UE, triggering the terminal UE to apply the target Secondary Cell Group (SCG) configuration, such as the Secondary Cell Group (SCG) change or the Primary Secondary Cell (PSCell) change.

As an example, the radio resource reconfiguration RRCReconfiguration message from the Secondary Node (SN) may be configured through a mrdc-SecondaryCellGroup domain, and thus the mrdc-SecondaryCellGroup includes the radio resource reconfiguration RRCReconfiguration message generated by the Secondary Node (SN). The RRC message may include the indication information. For example, the RRC message may only include the domain(s) secondaryCellGroup, otherConfig, conditionalReconfiguration, measConfig, bap-Config, IAB-IP-AddressConfigurationList, and a domain corresponding to the indication information.

In an embodiment, the mobility action is used for the primary cell change or the master cell group change and the second node is the Target-Master Node (T-MN), and a radio resource control reconfiguration RRCReconfiguration message is sent to the Source-Master Node (S-MN), wherein the radio resource control reconfiguration RRCReconfiguration message includes the indication information.

In an embodiment, the mobility action is used for the primary cell change or the master cell group change, and the first node is a Source-Master Node (S-MN) or a Source-Secondary Node (S-SN) of a primary secondary cell; or

the mobility action is used for the primary secondary cell change or the secondary cell group change, and the first node is a Master Node (MN).

In an embodiment, only the Source-Master Node (S-MN) or the current Master Node (MN) can directly send information to the UE, and the Target-Master Node (T-MN) or the Secondary Node (SN) cannot send indication information to the UE at the current moment.

In an embodiment, the indication information is included in a radio resource reconfiguration RRCReconfiguration message.

In an embodiment, the RRCReconfiguration message includes: a handover command message, used to indicate a cell handover or a cell group handover for the UE.

In this embodiment, the second node is the Target-Master Node (T-MN), the indication information is generated by the Target-Master Node (T-MN), and the first node is the Source-Master Node (S-MN). The Target-Master Node (T-MN) generates a radio resource control reconfiguration RRCReconfiguration message, and the radio resource control reconfiguration RRCReconfiguration message includes the indication information. The Target-Master Node (T-MN) sends the radio resource control reconfiguration RRCReconfiguration message to the Source-Master Node (S-MN), and the Source-Master Node (S-MN) forwards the radio resource control reconfiguration RRCReconfiguration message to the terminal. After receiving the radio resource control reconfiguration RRCReconfiguration message, the terminal can receive the indication information.

In an embodiment, the mobility action is used for the primary secondary cell change or the secondary cell group change and the second node is the Target-Master Node (T-MN), and a radio resource control reconfiguration RRCReconfiguration message is sent to the Source-Secondary Node (S-SN), wherein the radio resource control reconfiguration RRCReconfiguration message includes the indication information.

In this embodiment, the second node is the Target-Master Node (T-MN), the indication information is generated by the Target-Master Node (T-MN), and the first node is the Source-Secondary Node (S-SN). The Target-Master Node (T-MN) may generate a radio resource control reconfiguration RRCReconfiguration message including the indication information, and then send the generated radio resource control reconfiguration RRCReconfiguration message to the Source-Secondary Node (S-SN). The Source-Secondary Node (S-SN) receives the radio resource control reconfiguration RRCReconfiguration message sent by the Target-Master Node (T-MN). The Source-Secondary Node (S-SN) then sends the received radio resource control reconfiguration RRCReconfiguration message to the terminal, and the terminal can receive the indication information by receiving the radio resource control reconfiguration RRCReconfiguration message sent by the Source-Secondary Node (S-SN).

In an embodiment, the mobility action is used for the primary secondary cell change or the secondary cell group change and the second node is the Target-Secondary Node (T-SN), and a radio resource control reconfiguration RRCReconfiguration message is sent to the Source-Secondary Node (S-SN), wherein the radio resource control reconfiguration RRCReconfiguration message includes the indication information.

In this embodiment, the second node is the Target-Secondary Node (T-SN), the indication information is generated by the Target-Secondary Node (T-SN), and the first node is the Source-Secondary Node (S-SN). The Target-Secondary Node (T-SN) may generate a radio resource control reconfiguration RRCReconfiguration message including the indication information, and then send the generated radio resource control reconfiguration RRCReconfiguration message to the Source-Secondary Node (S-SN). The Source-Secondary Node (S-SN) receives the radio resource control reconfiguration RRCReconfiguration message sent by the Target-Secondary Node (T-SN). The Source-Secondary Node (S-SN) then sends the received radio resource control reconfiguration RRCReconfiguration message to the terminal, and the terminal can receive the indication information by receiving the radio resource control reconfiguration RRCReconfiguration message sent by the Source-Secondary Node (S-SN).

In an embodiment, the mobility action is used for the primary secondary cell change or the secondary cell group change and the second node is the Target-Secondary Node (T-SN), and a radio resource control reconfiguration RRCReconfiguration message is sent to the Source-Master Node (S-MN), wherein the radio resource control reconfiguration RRCReconfiguration message includes the indication information.

In this embodiment, the second node is the Target-Secondary Node (T-SN), the indication information is generated by the Target-Secondary Node (T-SN), and the first node is the Source-Master Node (S-MN). The Target-Secondary Node (T-SN) may generate a radio resource control reconfiguration RRCReconfiguration message including the indication information, and then send the generated radio resource control reconfiguration RRCReconfiguration message to the Source-Master Node (S-MN). The Source-Master Node (S-MN) receives the radio resource control reconfiguration RRCReconfiguration message sent by the Target-Secondary Node (T-SN). The Source-Master Node (S-MN) then sends the received radio resource control reconfiguration RRCReconfiguration message to the terminal, and the terminal can receive the indication information by receiving the radio resource control reconfiguration RRCReconfiguration message sent by the Source-Master Node (S-MN).

In an embodiment, the indication information corresponds to a preset field;

the indication information including the preset field is used to indicate retaining the configuration information related to the candidate cell or the candidate cell group; the indication information not including the preset field is used to indicate deleting the configuration information related to the candidate cell or the candidate cell group.

In an embodiment, the indication information corresponds to a preset field;

the indication information including the preset field is used to indicate deleting configuration information related to the candidate cell or the candidate cell group; the indication information not including the preset field is used to indicate retaining the configuration information related to the candidate cell or the candidate cell group.

In an embodiment, the indication information corresponds to a preset field;

a value of the preset field included in the indication information being a first value is used to indicate deleting the configuration information related to the candidate cell or the candidate cell group; the value of the preset field included in the indication information being a second value is used to indicate retaining the configuration information related to the candidate cell or the candidate cell group.

In an embodiment, the radio resource control reconfiguration RRCReconfiguration message includes:

a handover command.

In an embodiment, the indication information is used to indicate the terminal to delete or retain the LTM configuration or selective activation configuration stored by the terminal UE after performing a mobility action (e.g., a Secondary Cell Group (SCG) change). The terminal UE determines whether to retain or delete the stored LTM configuration based on the indication information, such as the candidate cell configuration corresponding to the LTM, for example, a configuration of the LTM of a Master Cell Group (MCG) or a Primary Cell (PCell) (e.g., a candidate MCG configuration), a configuration of the LTM of the Secondary Cell Group (SCG) or the Primary Secondary Cell (PSCell) (e.g., a candidate SCG configuration). And/or, the terminal UE determines whether to retain or release the conditional mobility configuration of selective activation based on the indication information.

Whether the radio resource control reconfiguration RRCReconfiguration message includes a preset field is used to indicate whether to delete or retain the configuration information related to the candidate cell or candidate cell group.

For example, if the first node sends the indication information or the mobility trigger command message of a response includes the indication information, the terminal UE retains the stored LTM and/or selective activation configuration. If the indication information is not included, the UE deletes the stored LTM and/or selective activation configuration. For another example, if the first node sends the indication information or the mobility trigger command message of the response includes the indication information, the terminal UE deletes the stored LTM and/or selective activation configuration. If the indication information is not included, the terminal UE retains the stored LTM and/or selective activation configuration.

In an embodiment, the radio resource control reconfiguration RRCReconfiguration message including the preset field is used to indicate deleting the configuration information related to the candidate cell or the candidate cell group. The radio resource control reconfiguration RRCReconfiguration message not including the preset field is used to indicate retaining the configuration information related to the candidate cell or the candidate cell group.

In an embodiment, the radio resource control reconfiguration RRCReconfiguration message including the preset field is used to indicate retaining the configuration information related to the candidate cell or candidate cell group. The radio resource control reconfiguration RRCReconfiguration message not including the preset field is used to indicate deleting the configuration information related to the candidate cell or candidate cell group.

In an embodiment, the value of the preset field included in the radio resource control reconfiguration RRCReconfiguration message is used to indicate deleting or retaining the configuration information related to the candidate cell or the candidate cell group.

The preset field may be determined according to actual usage requirements and is not limited here.

In an embodiment, the value of the preset field included in the radio resource control reconfiguration RRCReconfiguration message being a first value is used to indicate deleting the configuration information related to the candidate cell or the candidate cell group. The value of the preset field included in the radio resource control reconfiguration RRCReconfiguration message being a second value is used to indicate retaining the configuration information related to the candidate cell or the candidate cell group. In an embodiment, the value of the preset field included in the radio resource control reconfiguration RRCReconfiguration message being the second value is used to indicate deleting the configuration information related to the candidate cell or the candidate cell group. The value of the preset field included in the radio resource control reconfiguration RRCReconfiguration message being the first value is used to indicate retaining the configuration information related to the candidate cell or the candidate cell group.

As an example, the first node sends the indication information or the mobility trigger command message of a response includes the indication information, and the indication information is a first specific value, the terminal UE deletes the stored LTM and/or selective activation configuration; if the indication information is a second specific value, the terminal UE retains the stored LTM and/or selective activation configuration.

In an embodiment, in response to the terminal UE receiving a radio resource control reconfiguration RRCReconfiguration message sent by the first node, the radio resource control reconfiguration RRCReconfiguration includes a MCG configuration carrying a synchronization reconfiguration. The radio resource control reconfiguration RRCReconfiguration message includes a handover command.

If the terminal UE receives a radio resource control reconfiguration RRCReconfiguration message from the Target-Master Node (T-MN) forwarded by the Source-Master Node (S-MN) and the RRCReconfiguration message includes the indication information or the indication information is a specific value, the terminal UE deletes the LTM candidate cell configuration, deletes the candidate MCG configuration and/or the candidate SCG configuration; otherwise, the terminal UE retains the LTM candidate cell configuration, retains the candidate MCG configuration and/or the candidate SCG configuration.

If the terminal UE receives the radio resource control reconfiguration RRCReconfiguration message sent by the Source-Master Node (S-MN) and the RRCReconfiguration message includes the indication information or a value of the indication information is a specific value, or the terminal UE receives the indication information sent by the Source-Master Node (S-MN), the terminal UE deletes the LTM candidate cell configuration, deletes the candidate MCG configuration and/or the candidate SCG configuration; otherwise, the terminal UE retains the LTM candidate cell configuration, retains the candidate MCG configuration and/or the candidate SCG configuration.

In an embodiment, in response to that the radio resource control reconfiguration RRCReconfiguration message sent by the Source-Master Node (S-MN) and received by the terminal UE or the radio resource control reconfiguration RRCReconfiguration message of the Target-Master Node (T-MN) forwarded by the Source-Master Node (S-MN) includes the indication information or the indication information is a specific value, and the UE handover is successful (for example, the UE successfully accesses the target cell PCell), the terminal UE deletes the LTM candidate cell configuration, deletes the candidate MCG configuration and/or the candidate SCG configuration; otherwise, the terminal UE retains the LTM candidate cell configuration, retains the candidate MCG configuration and/or the candidate SCG configuration.

In an embodiment, in response to the terminal UE receiving a message sent by the network to trigger a Secondary Cell Group (SCG) change, for example, receiving a radio resource control reconfiguration RRCReconfiguration message sent by the first node, this radio resource control reconfiguration RRCReconfiguration includes a SCG configuration carrying a synchronization reconfiguration, including the indication information.

In an embodiment, if the terminal UE receives the Secondary Node (SN) radio resource control reconfiguration RRCReconfiguration message from the Target-Secondary Node (T-SN) forwarded by the Master Node (MN) and the SN RRCReconfiguration message includes the indication information or the indication information is a specific value, the terminal UE deletes the LTM candidate cell configuration and deletes the candidate SCG configuration; otherwise, the terminal UE retains the LTM candidate cell configuration and retains the candidate SCG configuration.

In an embodiment, if the terminal UE receives a Master Node (MN) radio resource control reconfiguration RRCReconfiguration message sent by the Master Node (MN), and the MN RRCReconfiguration message includes a Secondary Node (SN) radio resource control reconfiguration RRCReconfiguration message and also includes the indication information or the indication information is a specific value, or the UE receives indication information sent by the Master Node (MN), the terminal UE deletes the LTM candidate cell configuration and deletes the candidate SCG configuration; otherwise, the terminal UE retains the LTM candidate cell configuration and retains the candidate SCG configuration.

In an embodiment, when the terminal UE receives the indication information sent by the Source-Secondary Node (S-SN), the terminal UE deletes the candidate target configuration of the LTM and deletes the candidate SCG configuration; otherwise, the terminal UE retains the LTM candidate cell configuration and retains the candidate SCG configuration.

In an embodiment, in response to that the terminal UE receives a radio resource control reconfiguration RRCReconfiguration message sent by the Master Node (MN) or a radio resource control reconfiguration RRCReconfiguration message of the Target-Master Node (T-MN) forwarded by the Master Node (MN) and the RRCReconfiguration message includes the indication information or the indication information is a specific value, or the terminal UE receives the indication information sent by the Master Node (MN) or the Target-Secondary Node (T-SN), and the terminal UE successfully performs the Secondary Cell Group (SCG) change (for example, the UE successfully accesses the target cell PSCell), the terminal UE deletes the LTM candidate cell configuration and deletes the candidate SCG configuration; otherwise, the terminal UE retains the LTM candidate cell configuration and retains the candidate SCG configuration.

In an embodiment, deleting the candidate target configuration of the LTM refers to deleting all candidate target configuration(s) stored in the terminal UE, for example, all candidate MCG configuration(s) and/or all candidate SCG configuration(s), rather than configuration(s) of a specific candidate MCG or candidate SCG.

In an embodiment, the terminal UE receives one or more pieces of configuration information of condition-based mobility sent by the first node, where the conditional mobility configuration information is used for SCG selective activation, and the terminal UE receives and stores the configuration(s).

In an embodiment, in response to the terminal UE receiving a handover command (MCG change) sent by the first node, a radio resource control reconfiguration RRCReconfiguration message sent by the network is received, and the radio resource control reconfiguration RRCReconfiguration includes a MCG configuration carrying a synchronization reconfiguration.

In an embodiment, if the radio resource control reconfiguration RRCReconfiguration message forwarded by the Source-Target Master Node (S-MN) from the Target-Master Node (T-MN) includes the indication information or the indication information is a specific value, the terminal UE deletes the configuration information of condition-based mobility, and the configuration information is used for SCG selective activation; otherwise, the terminal UE retains the LTM candidate cell configuration and retains the candidate SCG configuration.

In an embodiment, if the radio resource control reconfiguration RRCReconfiguration message sent by the Source-Target Master Node (S-MN) includes the indication information or the indication information is a specific value, or the terminal UE receives the indication information sent by the Source-Target Master Node (S-MN), the terminal UE deletes the configuration information of condition-based mobility, and the configuration information is used for SCG selective activation; otherwise, the terminal UE retains the LTM candidate cell configuration and retains the candidate SCG configuration.

In an embodiment, in response to that the terminal UE receives the radio resource control reconfiguration RRCReconfiguration message sent by the Source-Target Master Node (S-MN) or the radio resource control reconfiguration RRCReconfiguration message of the Target-Master Node (T-MN) forwarded by the Source-Target Master Node (S-MN) and the RRCReconfiguration message includes the indication information or the indication information is a specific value, and the terminal UE handover is successful (for example, the UE successfully accesses the target cell PCell), the terminal UE deletes the configuration information of condition-based mobility, and the configuration information is used for SCG selective activation; otherwise, the terminal UE retains the LTM candidate cell configuration and retains the candidate SCG configuration.

In an embodiment, the terminal UE receiving the radio resource control reconfiguration RRCReconfiguration message which includes a synchronization reconfiguration and is sent by the first node also includes the following situation:

the terminal UE triggers condition-based mobility for CHO/CPAC and a corresponding condRRCReconfig is applied.

As an example, if the terminal UE triggers condition-based mobility for CHO/CPAC, the corresponding condRRCReconfig is applied. If the radio resource control reconfiguration RRCReconfiguration message corresponding to condRRCReconfig (such as the radio resource control reconfiguration RRCReconfiguration message from the Target-Master Node (T-MN) or the Target-Secondary Node (T-SN)) includes the indication information, or the indication information is a specific value, the terminal deletes the LTM configuration or the selective activation configuration.

In an embodiment, the indication information further includes: a mobility command;
the mobility command is used to indicate at least one of the following:
indicating a cell or cell group change between different Central Units (CUs);
indicating a cell or cell group change in the same CU;
indicating a cell or cell group change between different access technologies;
indicating a cell or cell group change between different master nodes;
indicating a cell or cell group change in the same master node.

In an embodiment, the indication information may also indicate whether a corresponding mobility command, such as a handover command or SCG, is for the same CU (intra-CU) or the same node (intra-node) or different access technologies (inter-RAT). The UE determines whether to delete the LTM configuration or selective activation configuration stored in the UE according to the indication information.

As an example, if the mobility command received by the UE is inter-RAT mobility, the UE deletes the stored LTM configuration or selective activation configuration. The same node may include: the same master node and/or the same secondary node.

As an example, if the mobility command received by the UE is inter-CU or inter-node mobility, the UE deletes the stored LTM configuration or selective activation configuration.

As an example, the same node may include: the same master node and/or the same secondary node.

As an example, the mobility command may include information about a cell or cell group change after a mobility action is triggered.

In an embodiment, the indication information is used to indicate the UE to perform a mobility action between different access technologies and to delete the configuration information related to the candidate cell or candidate cell group stored by the UE; or

the indication information is used to indicate the UE to perform a mobility action between different Central Units (CUs), and to delete the configuration information related to the candidate cell or candidate cell group stored by the UE;
the indication information is used to indicate the UE to perform a mobility action between different Master Nodes (MNs), and to delete configuration information related to a candidate cell or a candidate cell group stored by the UE; or
the indication information is used to indicate the UE to perform a mobility action in the same Master Node (MN), and to retain the configuration information related to the candidate cell or candidate cell group stored by the UE.

In an embodiment, an information processing method is provided. The method includes:
sending, by a first node, indication information, wherein the indication information is used to indicate user equipment to retain or delete configuration information related to a candidate cell or a candidate cell group stored by the user equipment when a mobility action is triggered; and
receiving, by the user equipment, the indication information.

In an embodiment, an information processing method is provided. The method includes:
sending, by a second node, indication information to a first node, wherein the indication information is used for user equipment to indicate the user equipment to retain or delete configuration information related to a candidate cell or a candidate cell group stored by the user equipment when a mobility action is triggered after the indication information is sent by the first node to the user equipment; and
receiving, by the first node, the indication information, and sending the indication information to the user equipment.

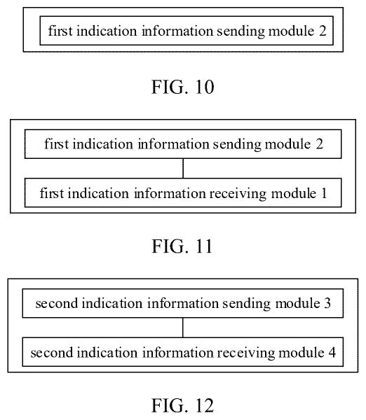

In an embodiment, referring to FIG. 9, a schematic diagram of an information processing apparatus is shown. The apparatus is applied to user equipment. The apparatus includes:
a first indication information receiving module 1 configured to receive
indication information sent by a first node, wherein the indication information is used to indicate the user equipment to retain or delete configuration information related to a candidate cell or a candidate cell group when a mobility action is triggered.

In an embodiment, referring to FIG. 10, another information processing apparatus is shown. The apparatus is applied to a first node. The apparatus includes:

a first indication information sending module 2 configured to send indication information to user equipment, wherein the indication information is used to indicate the user equipment to retain or delete configuration information related to a candidate cell or a candidate cell group when a mobility action is triggered.

In an embodiment, referring to FIG. 11, a wireless communication system is shown. The system includes:
a first indication information sending module 2 configured as a first node to send indication information to user equipment, wherein the indication information is used to indicate the user equipment to retain or delete configuration information related to a candidate cell or a candidate cell group when a mobility action is triggered; and
a first indication information receiving module 1 configured as the user equipment to receive the indication information.

In an embodiment, referring to FIG. 12, another wireless communication system is shown. The system includes:
a second indication information sending module 3 configured as a second node to send indication information to a first node, wherein the indication information is used for user equipment to indicate the user equipment to retain or delete configuration information related to a candidate cell or a candidate cell group stored by the user equipment when a mobility action is triggered after the indication information is sent by the first node to the user equipment; and
a second indication information receiving module 4 configured as the first node to receive the indication information and send the indication information to the user equipment.

In an embodiment, a communication device is also provided. The communication device includes a processor, a transceiver, a memory, and an executable program stored in the memory and capable of being run by the processor. When the processor runs the executable program, the information processing method provided in any of the above embodiments is implemented.

In an embodiment, a computer storage medium is further provided. The computer storage medium stores an executable program. After the executable program is executed by a processor, the information processing method provided in any of the above embodiments can be implemented.

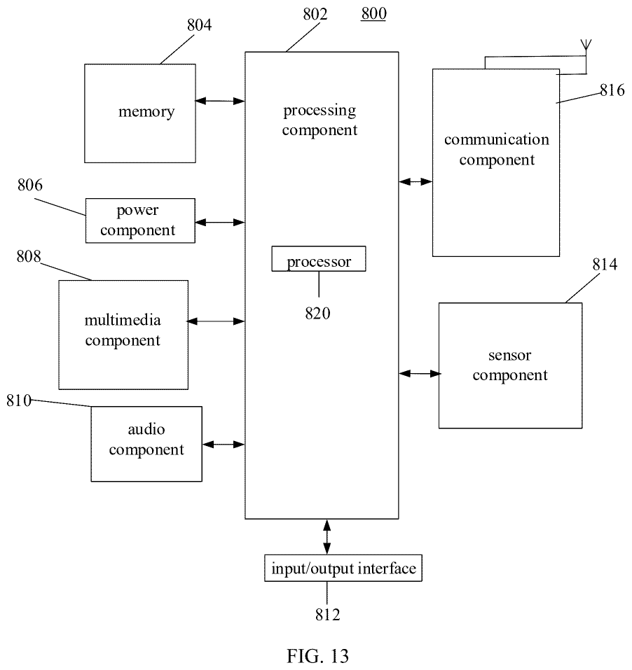

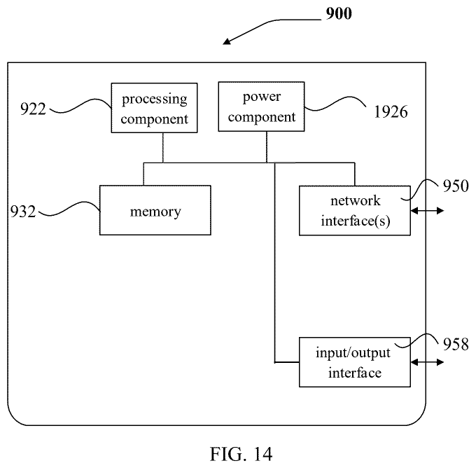

FIG. 13 is a block diagram of UE 800 according to an example embodiment. For example, the UE 800 may be a mobile phone, a computer, digital broadcast user equipment, a messaging device, a gaming console, a tablet, a medical device, exercise equipment, a personal digital assistant, and the like.

Referring to FIG. 13, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the UE 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the UE 800. Examples of such data include instructions for any applications or methods operated on the UE 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the UE 800. The power component 806 may include a power management system, one or more power sources, and any other components associated with the generation, management, and distribution of power in the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the UE 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the UE 800. For instance, the sensor component 814 may detect an open/closed status of the UE 800, relative positioning of components, e.g., the display and the keypad, of the UE 800, a change in position of the UE 800 or a component of the UE 800, a presence or absence of user contact with the UE 800, an orientation or an acceleration/deceleration of the UE 800, and a change in temperature of the UE 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the UE 800 and other devices. The UE 800 can access a wireless network based on a communication standard, such as WiFi, 2G, or 3G, or a combination thereof. In one example embodiment, the communication component 816 receives a broadcast signal or broadcast associated information from an external broadcast management system via a broadcast channel. In one example embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the UE 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 804 including instructions executable by the processor 820 in the UE 800, for performing the above-described methods. For example, the non-transitory computer-readable storage medium may be a ROM, a Random Access Memory (RAM), a CD-ROM, a magnetic tape, a floppy disc, an optical data storage device, and the like.

As shown in FIG. 14, an embodiment of the present disclosure shows a structure of an access device. For example, the communication device 900 may be provided as a network device. The communication device may be various network element(s) such as the access network element and/or the network function as described above, etc.

Referring to FIG. 14, the communication device 900 includes a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform any of the above described methods which are applied at the access device, such as, any of the methods shown in FIG. 4 to FIG. 9.

The communication device 900 may also include a power component 1926 configured to perform power management of the communication device 900, wired or wireless network interface(s) 950 configured to connect the communication device 900 to a network, and an input/output (I/O) interface 958. The communication device 900 may operate based on an operating system stored in the memory 932, such as Windows Server™, Mac OS X™ Unix™, Linux™, FreeBSD™, or the like.

Further example embodiments are provided as follows:

An embodiment of the present disclosure provides an information processing method. The method includes:

sending, by a first node, indication information, wherein the indication information is used to indicate user equipment to retain or delete configuration information related to a candidate cell or a candidate cell group stored by the user equipment; and receiving, by the user equipment, the indication information.

An embodiment of the present disclosure provides an information processing method. The method includes:
sending, by a second node, indication information to a first node, wherein the indication information is used to indicate the user equipment to retain or delete configuration information related to a candidate cell or a candidate cell group stored by the user equipment when a mobility action is triggered after the indication information is sent by the first node to the user equipment; and
receiving, by the first node, the indication information, and sending the indication information to the user equipment.

An embodiment of the present disclosure provides an information processing apparatus. The apparatus is applied to user equipment. The apparatus includes:

a first indication information receiving module configured to receive indication information sent by a first node, wherein the indication information is used to indicate the user equipment to retain or delete configuration information related to a candidate cell or a candidate cell group stored by the user equipment when a mobility action is triggered.

An embodiment of the present disclosure provides an information processing apparatus. The apparatus is applied to a first node. The apparatus includes:

a first indication information sending module configured to send indication information to user equipment, wherein the indication information is used to indicate the user equipment to retain or delete configuration information related to a candidate cell or a candidate cell group stored by the user equipment when a mobility action is triggered.

An embodiment of the present disclosure provides a wireless communication system, including:
a first indication information sending module configured as a first node to send
indication information to user equipment, wherein the indication information is used to indicate the user equipment to retain or delete configuration information related to a candidate cell or a candidate cell group stored by the user equipment when a mobility action is triggered; and a first indication information receiving module configured as the use equipment
to receive the indication information.

An embodiment of the present disclosure provides a wireless communication system, including:
a second indication information sending module configured as a second node to send indication information to a first node, wherein the indication information is used to indicate the user equipment to retain or delete configuration information related to a candidate cell or a candidate cell group stored by the user equipment when a mobility action is triggered after the indication information is sent by the first node to the user equipment; and
a second indication information receiving module configured as the first node to receive the indication information and send the indication information to the user equipment.

According to the information processing method provided by the embodiments of the present disclosure, when the user equipment needs to trigger a mobility action, it indicates that the candidate cell or the candidate cell group of the user equipment may change, and the configuration information related to the candidate cell or candidate cell group currently stored by the user equipment may no longer be applicable, or may be applicable. Thus, the user equipment receives the indication information sent by the first node, and the indication information can be used by the user equipment to determine whether the user equipment needs to retain or delete the configuration information related to the candidate cell or the candidate cell group currently stored by the user equipment itself. The method can reduce a phenomenon in the related art that the UE does not receive the indication information and cannot know whether it is needed to delete the configuration information related to the candidate cell or candidate cell group, and after the UE performs the mobility action, the use of wrong configuration information related to the candidate cell or candidate cell group causes a failure in accessing a serving cell or a serving cell group or poor communication quality after access. Accordingly, the method can improve the access success rate and/or the communication quality of the user equipment.

Other implementations of the embodiments of the disclosure will be apparent to those skilled in the art from consideration of the specification and practice of the disclosure disclosed here. This application is intended to cover any variations, uses, or adaptations of embodiments of the present disclosure following the general principles thereof and including such departures from the present disclosure as come within known or customary practice in the art. It is intended that the specification and examples be considered as exemplary only, with a true scope and spirit of the embodiments of the present disclosure being indicated by the following claims.

It will be appreciated that the embodiments of the present disclosure are not limited to the exact construction that has been described above and illustrated in the accompanying drawings, and that various modifications and changes can be made without departing from the scope thereof. It is intended that the scope of the embodiments of the present disclosure only be limited by the appended claims.

1. An information processing method, wherein the method is performed by user equipment (UE), and comprises:
receiving indication information sent by a first node, wherein the indication information indicates the UE to retain or delete configuration information related to a candidate cell or a candidate cell group stored by the UE.

2. The method according to claim 1, wherein:
the indication information indicates the UE to retain or delete the configuration information during, after, or before performing a mobility procedure.

3. The method according to claim 1, wherein:
a mobility procedure is used for a primary cell change or a master cell group change, and the indication information indicates the UE to delete configuration information related to a candidate primary cell or a candidate master cell group, and to delete configuration information related to a candidate secondary cell or a candidate secondary cell group; or
the mobility procedure is used for a primary secondary cell change or a secondary cell group change, and the indication information indicates the UE to delete the configuration information related to the candidate secondary cell or the candidate secondary cell group; or
the mobility procedure is used for the primary cell change or the master cell group change, and the indication information indicates the UE to retain the configuration information related to the candidate primary cell or the candidate master cell group, and to retain the configuration information related to the candidate secondary cell or the candidate secondary cell group; or
the mobility procedure is used for the primary secondary cell change or the secondary cell group change, and the indication information indicates the UE to retain the configuration information related to the candidate secondary cell or the candidate secondary cell group.

4. The method according to claim 1, wherein receiving the indication information sent by the first node comprises:
receiving mobility configuration information sent by the first node, wherein the mobility configuration information comprises the indication information.

5. The method according to claim 1, wherein the configuration information related to the candidate cell or the candidate cell group comprises at least one of:
L1/L2 Triggered Mobility (LTM) configuration information of the candidate cell or the candidate cell group; or
selective activation configuration information of the candidate cell or the candidate cell group.

6. The method according to claim 1, wherein:
a mobility procedure is used for a primary cell change or a master cell group change, and the indication information is generated by a Target-Master Node (T-MN); or
the mobility procedure is used for the primary cell change or the master cell group change, and the indication information is generated by a Source-Master Node (S-MN); or
the mobility procedure is used for a primary secondary cell change or a secondary cell group change, and the indication information is generated by a Target-Secondary Node (T-SN); or
the mobility procedure is used for the primary secondary cell change or the secondary cell group change, and the indication information is generated by a Source-Secondary Node (S-SN); or
the mobility procedure is used for a secondary cell change, and the indication information is generated by a Master Node (MN) or a Secondary Node (SN).

7. The method according to claim 1, wherein:
a mobility procedure is used for a primary cell change or a master cell group change, and the first node is a Source-Master Node (S-MN) or a Source-Secondary Node (S-SN) of a primary secondary cell; or
the mobility procedure is used for a primary secondary cell change or a secondary cell group change, and the first node is a Master Node (MN).

8. The method according to claim 1, wherein the indication information is comprised in a radio resource reconfiguration (RRCReconfiguration) message.

9. The method according to claim 8, wherein the RRCReconfiguration message comprises: a handover command message, configured to indicate a cell handover or a cell group handover for the UE.

10. The method according to claim 1, wherein:
the indication information comprising a preset field indicates retaining the configuration information related to the candidate cell or the candidate cell group; the indication information not comprising the preset field indicates deleting the configuration information related to the candidate cell or the candidate cell group; or
the indication information comprising the preset field indicates deleting the configuration information related to the candidate cell or the candidate cell group; the indication information not comprising the preset field indicates retaining the configuration information related to the candidate cell or the candidate cell group; or
a value of the preset field comprised in the indication information being a first value indicates deleting the configuration information related to the candidate cell or the candidate cell group; the value of the preset field comprised in the indication information being a second value indicates retaining the configuration information related to the candidate cell or the candidate cell group.

11. The method according to claim 1, wherein the indication information further comprises: a mobility command;
wherein the mobility command indicates at least one of:
a cell or cell group change between different Central Units (CUs);
a cell or cell group change in a same CU;
a cell or cell group change between different access technologies;
a cell or cell group change between different master nodes; or
a cell or cell group change in a same master node.

12. The method according to claim 1, wherein:
the indication information indicates the UE to perform a mobility procedure between different access technologies and to delete the configuration information related to the candidate cell or the candidate cell group stored by the UE; or
the indication information indicates the UE to perform a mobility procedure between different Central Units (CUs), and to delete the configuration information related to the candidate cell or the candidate cell group stored by the UE; or
the indication information indicates the UE to perform a mobility procedure between different Master Nodes (MNs), and to delete the configuration information related to the candidate cell or the candidate cell group stored by the UE; or
the indication information indicates the UE to perform a mobility procedure in a same Master Node (MN), and to retain the configuration information related to the candidate cell or the candidate cell group stored by the UE.

13. An information processing method, wherein the method is performed by a first node, and comprises:
sending indication information to user equipment (UE), wherein the indication information indicates the UE to retain or delete configuration information related to a candidate cell or a candidate cell group stored by the UE.

14.-22. (canceled)

23. The method according to claim 13, wherein the indication information corresponds to a preset field;
wherein the indication information comprising the preset field indicates retaining the configuration information related to the candidate cell or the candidate cell group; the indication information not comprising the preset field indicates deleting the configuration information related to the candidate cell or the candidate cell group; or
wherein the indication information comprising the preset field indicates deleting the configuration information related to the candidate cell or the candidate cell group; the indication information not comprising the preset field indicates retaining the configuration information related to the candidate cell or the candidate cell group; or
wherein a value of the preset field comprised in the indication information being a first value indicates deleting the configuration information related to the candidate cell or the candidate cell group; the value of the preset field comprised in the indication information being a second value indicates retaining the configuration information related to the candidate cell or the candidate cell group.

24. The method according to claim 13, wherein the indication information further comprises: a mobility command;
wherein the mobility command indicates at least one of:
a cell or cell group change between different Central Units (CUs);
a cell or cell group change in a same CU;
indicating a cell or cell group change between different access technologies;
a cell or cell group change between different master nodes;
a cell or cell group change in a same master node.

25. The method according to claim 13, wherein:
the indication information indicates the UE to perform a mobility procedure between different access technologies and to delete the configuration information related to the candidate cell or the candidate cell group stored by the UE; or
the indication information indicates the UE to perform a mobility procedure between different Central Units (CUs), and to delete the configuration information related to the candidate cell or candidate cell group stored by the UE; or
the indication information indicates the UE to perform a mobility procedure between different Master Nodes (MNs), and to delete the configuration information related to the candidate cell or the candidate cell group stored by the UE; or
the indication information indicates the UE to perform a mobility procedure in a same Master Node (MN), and to retain the configuration information related to the candidate cell or the candidate cell group stored by the UE.

26. (canceled)

27. (canceled)

28. A communication device, comprising:
a processor;
a transceiver; and
a memory storing a program executable by the processor,
wherein the processor is configured to:
receive indication information sent by a first node, wherein the indication information indicates user equipment (UE) to retain or delete configuration information related to a candidate cell or a candidate cell group stored by the UE.

29. A non-transitory computer storage medium storing an executable program that, when executed by a processor, causes the processor to perform the information processing method according to claim 1.

30. A communication device, comprising:
a processor;
a transceiver; and
a memory storing a program executable by the processor,
wherein the processor is configured to perform the method according to claim 13.

31. A non-transitory computer storage medium storing an executable program that, when executed by a processor, causes the processor to perform the information processing method according to claim 13.
